(19) United States
(12) Patent Application Publication
(10) Pub. No.: US 2025/0139397 A1
(43) Pub. Date: May 1, 2025

(54) RFID-Enabled Transaction Cards Of Metal And Plastic

(71) Applicant: Federal Card Services, LLC, Cincinnati, OH (US)

(72) Inventors: David Finn, Fussen Weissensee (DE); Daniel Pierrard, Newport, KY (US)

(21) Appl. No.: 17/771,811

(22) PCT Filed: Oct. 26, 2020
(86) PCT No.: PCT/US2020/057282

§ 371 Date: Apr. 25, 2022

Related U.S. Application Data
(63) Continuation of application No. 16/993,295, filed on Aug. 14, 2020.
Application No. 16/993,295 is a continuation of application No. 17/019,378, filed on Sep. 14, 2020, now Pat. No. 11,416,728.
(60) Provisional application No. 62/925,255, filed on Oct. 24, 2019.
(60) Provisional application No. 62/933,526, filed on Nov. 11, 2019.
(60) Provisional application No. 62/979,440, filed on Feb. 21, 2020.
(60) Provisional application No. 62/981,040, filed on Feb. 25, 2020.
(60) Provisional application No. 62/986,612, filed on Mar. 6, 2020.
(60) Provisional application No. 63/004,491, filed on Apr. 2, 2020.
(60) Provisional application No. 63/014,142, filed on Apr. 23, 2020.
(60) Provisional application No. 62/936,453, filed on Nov. 16, 2019.

(51) Int. Cl. G06K 19/02; G06K 19/07

(52) U.S. Cl. CPC G06K 19/02; G06K 19/0723

(57) ABSTRACT

An RFID-enabled metal face transaction card may comprise a thin front face metal layer (ML 1) with a “P1” module opening (MO) and a micro-slit (SI), and a thick metal layer (ML2) with “P2” module opening and a narrow slit. The metal layer (ML 1) may be color printed or coated, and have its surface protected by a laser-reactive diamond coat. The two metal layers may be separated by a PEN dielectric with a thermosetting epoxy on both sides which has been cured to an irreversible state (C-stage). The “P2” module opening in the metal layer (ML2) may have a shape and geometry which matches the shape and geometry of the module antenna (MA) of a transponder chip module (TCM). The shape of the “P1” and “P2” openings may be polygonal in form. The “P1” module opening in the metal layer (ML1) may have an alignment feature (GP) for ensuring correct alignment of the transponder chip module, when it is inserted into the openings.

### CROSS-REFERENCES TO RELATED APPLICATIONS

Priority (filing date benefit) is claimed from the following, incorporated by reference herein:
a continuation-in-part of U.S. Pat. No. 17,019,378 filed 14 Sep. 2020
a continuation-in-part of U.S. Pat. No. 16,993,295 filed 14 Aug. 2020
16993295 is a nonprovisional of 63/014,142 filed 23 Apr. 2020
16993295 is a nonprovisional of 62/986,612 filed 6 Mar. 2020
16993295 is a nonprovisional of 62/981,040 filed 25 Feb. 2020
nonprovisional of 63/004,491 filed 2 Apr. 2020
nonprovisional of 62/979,440 filed 21 Feb. 2020
nonprovisional of 62/936,453 filed 16 Nov. 2019
nonprovisional of 62/933,526 filed 11 Nov. 2019
nonprovisional of 62/925,255 filed 24 Oct. 2019

### FIELD OF THE INVENTION

This disclosure relates to the field of transaction cards (aka smartcards, or simply “cards”) and, more particularly, to cards which may have one or more layers of metal, including metal cards which are RFID-enabled (capable of functioning with a contactless interface).

This disclosure may relate to RFID-enabled smartcards, such as metal transaction cards and, more particularly, to RFID-enabled transaction cards and, more particularly, ESD protected metal-containing transaction cards having at least one layer of metal with a slit.

This disclosure may relate to RFID-enabled smartcards, such as metal transaction cards and, more particularly, to metal transaction cards, having at least one plastic layer and at least one metal layer with a slit or reinforced slit, which are capable of radio frequency (RF) communication.

This disclosure may relate to the field of metal transaction cards (aka smartcards, or simply “cards”) and more particularly dual interface metal transaction cards, having at least one plastic layer and at least one metal layer with a slit or reinforced slit, which are capable of radio frequency (RF) communication.

This disclosure may relate to metal transaction cards having electrostatic discharge (ESD) protection.

This disclosure may relate to metal face transaction cards having at least two layers of metal with a slit to act as a coupling frame (CF), having a first module opening P1 in the front face metal layer and having a second module opening P2 in the supporting metal layer, with the module openings machined to accept the insertion and shape of a transponder chip module (TCM) or an inductive coupling chip module (ICM) having an adhesive tape layer on its antenna side for attachment to the metal ledge which surrounds the P2 opening in the supporting metal layer, and with said antenna overlapping a portion of the metal ledge.

This disclosure may relate to maximizing the RF performance of a dual interface metal face transaction card by matching the shapes and geometries of the openings in the metal layers to the shape and geometry of the module antenna on the rear side of a transponder chip module.

Some of the disclosure(s) herein may relate to transaction cards having only a contactless interface, only a contact interface or both (dual interface).

### BACKGROUND OF THE INVENTION

A smartcard is an example of an RFID device that has a transponder chip module (TCM) or an inductive coupling chip module (ICM) disposed in a card body (CB) or inlay substrate.

When operating in a contactless mode, a passive transponder chip module (TCM) or inductive coupling chip module (ICM) may be powered by RF from an external RFID reader, and may also communicate by RF with the external RFID reader.

A dual-interface transponder chip module (TCM) or inductive coupling chip module (ICM) may also have a contact pad array (CPA), typically comprising 6 or 8 contact pads (CP, or “ISO pads”) disposed on a “face-up side” or “contact side” (or surface) of the module tape (MT), for interfacing with a contact reader in a contact mode (ISO 7816). A connection bridge (CBR) may be disposed on the face-up side of the tape for effecting a connection between two components such as the module antenna and the RFID chip on the other face-down side of the module tape.

Some smartcards have a card body comprising one or more metal layers (ML), or an entire metal card body (MCB). Since the metal layer(s) or card body may substantially attenuate the contactless (RF) capability of the card, RFID Slit technology was introduced, which generally comprises providing a slit in the metal layer(s) or metal card body. RFID Slit technology is discussed in greater detail hereinbelow. A metal layer or metal card body with a slit may be referred to as a “coupling frame”.

Generally, in the prior art, a coupling frame (CF) comprises a metal layer (ML) or metal card body (MCB) having a slit (S) extending from a peripheral edge of the metal layer or metal card body to an opening (MO) for receiving a transponder chip module (TCM) comprising an RFID chip (IC) and a module antenna (MA), for enabling a contactless interface. A dual-interface module may also have contact pads (CP) for enabling a contact interface.

The following are some examples of smartcards having coupling frames.

U.S. Pat. No. 9,475,086 (2016 Oct. 25; Finn et al.) discloses smartcard with coupling frame and method of increasing activation distance of a transponder chip module. A conductive coupling frame (CF) having two ends, forming an open loop, disposed surrounding and closely adjacent a transponder chip module (TCM), and substantially coplanar with an antenna structure (AS, LES) in the transponder chip module (TCM). A metal card body (MCB) having a slit (S) extending from a module opening (MO) to a periphery of the card body to function as a coupling frame (CF). The coupling frame (CF) may be thick enough to be non-transparent to RF at frequencies of interest. A switch may be provided to connect ends of the coupling frame (CF) across the slit (S). The transponder chip module (TCM) may comprise a laser-etched antenna structure (LES) and a non-perforated contact pad (CP) arrangement.

U.S. Pat. No. 9,697,459 (2017 Oct. 4; Finn et al.) discloses passive smart cards, metal cards, payment objects and smart jewelry. RFID devices comprising (i) a transponder chip module (TCM, 1410) having an RFIC chip (IC) and a module antenna (MA), and (ii) a coupling frame (CF) having an electrical discontinuity comprising a slit (S) or non-conductive stripe (NCS). The coupling frame may be disposed closely adjacent the transponder chip module so that the slit overlaps the module antenna. The RFID device may be a payment object such as a jewelry item having a metal component modified with a slit (S) to function as a coupling frame. The coupling frame may be moved (such as rotated) to position the slit to selectively overlap the module antennas (MA) of one or more transponder chip modules (TCM-1, TCM-2) disposed in the payment object, thereby selectively enhancing (including enabling) contactless communication between a given transponder chip module in the payment object and another RFID device such as an external contactless reader. The coupling frame may be tubular. A card body construction for a metal smart card is disclosed.

U.S. Pat. No. 9,798,968 (2017 Oct. 24; Finn et al.) discloses smartcard with coupling frame and method of increasing activation distance of a transponder chip module. A conductive coupling frame (CF) having two ends, forming an open loop having two ends or a discontinuous metal layer disposed surrounding and closely adjacent a transponder chip module (TCM, 610), and substantially coplanar with an antenna structure (AS, CES, LES) in the transponder chip module (TCM). A metal card body (MCB, CB) or a transaction card with a discontinuous metal layer having a slit (S) or a non-conductive strip (NCS, 1034) extending from a module opening (MO) to a periphery of the card body to function as a coupling frame (CF). The coupling frame (CF) may be thick enough to be non-transparent to RF at frequencies of interest. A switch (SW) may be provided to connect ends of the coupling frame (CF) across the slit (S, 630). A reinforcing structure (RS) may be provided to stabilize the coupling frame (CF) and card body (CB). The transponder chip module (TCM) may comprise an antenna structure which may be a laser-etched antenna structure (LES) or a chemical-etched antenna structure (CES), and may comprise and a non-perforated contact pad (CP) arrangement. A coupling frame (CF) may be incorporated onto the module tape (MT, CCT) for a transponder chip module (TCM). U.S. Pat. No. 9,836,684 (2017 Dec. 1; Finn et al.) discloses smart cards, payment objects and methods. Smartcards having (i) a metal card body (MCB) with a slit (S) overlapping a module antenna (MA) of a chip module (TCM) or (ii) multiple metal layers (M1, M2, M3) each having a slit (S1, S2, S3) offset or oriented differently than each other. A front metal layer may be continuous (no slit), and may be shielded from underlying metal layers by a shielding layer (SL). Metal backing inserts (MBI) reinforcing the slit(s) may also have a slit (S2) overlapping the module antenna. Diamond like coating filling the slit. Key fobs similarly fabricated. Plastic-Metal-Plastic smart cards and methods of manufacture are disclosed. Such cards may be contactless only, contact only, or may be dual-interface (contact and contactless) cards.

FIG. 3 of the '684 patent illustrates the front side of a smartcard (SC) 300 which may be a metal card having a metal layer (ML), which may constitute substantially the entire thickness of the card body (CB) 302. The card body (CB) may have a module opening (MO) 308 wherein a transponder chip module (TCM) 310 may be disposed, and a slit (S) 330 extending from the module opening (MO) to the outer perimeter of the metal layer (ML) so that the metal card body (MCB) 302 may function as a coupling frame (CF) 320.

The metal layer (ML) (or card body CB, or metal card body MCB) may comprise stainless steel or titanium, and is provided with a slit, slot or gap in the metal to create an open loop coupling frame closely adjacent to and substantially fully surrounding the transponder chip module (TCM). The slit (S) may overlap a portion of the module antenna (MA) 312 of the transponder chip module (TCM).

The smartcard 300 with a front side consisting of a metal layer may be referred to as a metal face smartcard. The slit may be a micro-slit having a width of less than 50 μm. The smartcard 300 may comprise of a metal layer sandwiched between two plastic layers and may be referred to as a metal core smartcard or an “embedded metal smartcard.

U.S. Pat. No. 9,960,476 (2018 May 1; Finn et al.) discloses smart card constructions. A conductive coupling frame (CF) or a discontinuous metal layer disposed surrounding and closely adjacent a transponder chip module (TCM), and substantially coplanar with an antenna structure (AS, CES, LES) in the transponder chip module (TCM). A metal card body (MCB, CB) or a transaction card with a discontinuous metal layer having a slit (S), extending from an inner end to a periphery of the metal layer, and not terminating in a distinct opening sized to accommodate a transponder chip module (TCM).

U.S. Pat. No. 10,193,211 (2019 Jan. 29; Finn et al.) discloses smartcards, RFID devices, wearables and methods. Coupling frames comprising a conductive (metal) surface with a slit (S) or non-conductive stripe (NCS) extending from an outer edge to an inner position thereof, and overlapping a transponder device. A coupling frame with slit for coupling with an inductive or capacitive device (inductor or capacitor) may be used at any ISM frequency band to concentrate surface current around the slit. The coupling frame can be tuned to operate at a frequency of interested by introducing a resistive, inductive or capacitive element. The resonance frequency of the coupling frame can be matched to that of the transponder chip module to achieve optimum performance. Coupling frames with or without a transponder device may be integrated, overlapping, stacked or placed adjacent to one another to enhance system performance. Multiple coupling frames may be electrically isolated from one another by the application of a dielectric coating such Diamond Like Carbon (DLC). 10,733,494 (2020 Aug. 4; Finn et al.) discloses CONTACTLESS METAL CARD CONSTRUCTIONS. A metal smartcard (SC) having a transponder chip module (TCM) with a module antenna (MA), and a card body (CB) comprising two discontinuous metal layers (ML), each layer having a slit (S) overlapping the module antenna, the slits being oriented differently than one another. One metal layer can be a front card body (FCB, CFJ), and the other layer may be a rear card body (RCB, CF2) having a magnetic stripe (MS) and a signature panel (SP).

The manufacture of transaction cards formed solely of a solid metal layer is known in the smartcard industry. These transaction cards are intended to provide an indication of status and wealth, and/or bestow a degree of prestige to the cardholder. However, pure metal transaction cards are difficult to equip with radio frequency transmission capability, because of the Faraday cage effect. In addition, they are generally much more costly to produce than the ubiquitous “plastic” smartcard.

Due to the prestige associated with metal cards, in terms of weight, feel and look, it has become fashionable for many card users to request a metal transaction card during renewal of their credit or debit cards. However, for payment convenience, the card user also requests contactless technology sometimes referred to as “Tap-to-Pay”.

In manufacturing a metal transaction card, the combination of metal and plastic simplifies the assembly of the magnetic stripe and the security elements (signature panel and hologram) to the card body. These component parts are laminated, adhesively attached and or hot stamped to the plastic layer. In addition, the plastic layer or layers attached to the metal layer or layers with a slit or reinforced slit provide mechanical strength to the card body construction.

However, major problems exist in the manufacture of a transaction card having a metal layer and a plastic layer, as indicated by the prior art with respect to warpage and delamination. The prior art suggests the separate lamination of the plastic subassemblies before laminating to a metal layer, by applying different pressure and temperature cycling profiles for each production step.

U.S. Pat. No. 8,672,232 (2014 Mar. 18; Herslow) discloses combination card of metal and plastic. A card which a first assembly comprised of multiple plastic layers attached via an adhesive to a metal layer. The multiple plastic layers forming the first assembly are laminated under a first selected temperature and pressure conditions to preshrink the multiple plastic layers, stress relieve the first assembly and render the first assembly dimensionally stable. The laminated first assembly is then attached to a metal layer via an adhesive layer to form a second assembly which is then laminated at a temperature below the first selected temperature to form a card which is not subjected to warpage and delamination.

U.S. Pat. No. 9,299,020 (2016 Mar. 29; Zimmerman et al.) discloses financial transaction card with cutout pattern representing symbolic information. A financial transaction card includes a card substrate formed as a material sheet having first and second substantially planar card faces bounded by a peripheral edge. A machine-readable financial information storage device is on or within the material sheet. The storage device stores card specific data in digital machine-readable form. Human readable symbolic information is viewable on the first and second card faces. At least one item of the symbolic information is formed as a cutout pattern of one or more light-transmitting apertures extending completely through the material sheet.

U.S. Pat. No. 10,583,683 (2020 Mar. 10; Ridenour et al.) discloses embedded metal card and related methods. A system and method for producing a multi-layered materials sheet that can be separated into a number of payment cards having an embedded metal layer that provides durability and aesthetics at a reduced cost and increased efficiency. During product of the materials sheet, multiple layers are collated and laminated to produce a large materials sheet. The lamination step involves heating and cooling the materials at specific temperatures and pressures for specific time periods. At a registration step, the sheet is automatically milled with alignment holes. During a singulation step, the alignment holes are used to position the sheet on a vacuum table, and vacuum holds the sheet in place while a milling device cuts cards from the sheet.

In addition to the abovementioned manufacturing problems, there are significant problems with the handling of solid metal and metal-containing smartcards, and their insertion or use in point of sale (POS) terminals. The presence of any metal layer may cause an electrostatic discharge (ESD) event or a short circuit. It is known that electronic circuitry in point of sale (POS) devices, used to execute financial transactions, are sensitive and susceptible to ESD events, caused by the transfer of an electrical charge from the card holder and the financial metal-containing transaction card to the POS device itself.

The presence of any metal in the financial transaction card increases the likelihood of such an ESD event. The ESD type of event can reset or damage the electronics in the POS terminal. Due to this phenomenon, a metal card or any card containing a metal layer of virtually any thickness [e.g., greater than 100 microns thick] can lead to catastrophic failure of the POS terminal or any like device in certain environments (e.g., cold, low humidity environments).

From a technical stance, the conducting elements of a metal-containing transaction card act as a capacitor against the GND plane, while transaction cards with an antenna can store more charge to damage the POS device. Metal-containing transaction cards get charged during usage (e.g. by rubbing on the personal clothes of the card holder or by charge induction from a charged person) and result in a hard discharge into a POS device.

U.S. Pat. No. 9,569,718 (2017 Feb. 14; Herslow, CompoSecure), incorporated by reference herein, discloses card with metal layer and electrostatic protection. A metal card or a hybrid metal-plastic includes an acrylic resin protective clear-coat layer and/or a “hard” nano-particle top-coat layer overlying any exposed metal surface in order to insulate the metal and reduce the likelihood of an electrostatic discharge (ESD) or a short circuit condition. In a particular embodiment the “hard” nano-particle top-coat layer overlies the clear coat layer. The dual stage protective layers which include a clear-coat layer and a top-coat ensure that the problem associated with an ESD and/or a short circuit condition is minimized. In addition, the dual stage protection imparted to a card by forming a clear-coat layer and a top-coat layer ensures that any card surface treatment or card decoration is protected over time from excessive wear or scratching due to use in conjunction with a POS device and/or handling.

The '718 patent suggests different ways to insulate a metal-containing transaction card to prevent an ESD event, by the application of a “clear coat layer” (18b) and a “hard coat layer” (20) to the front and or rear surface of the metal card, but the prior art is silent on the metal which is exposed at the perimeter edges of the metal card body, which may render the suggested protective measures futile.

Several technical problems arise in the manufacture of RFID enabled transaction cards having a metal face or a metal core construction, because of conflicting requirements in terms of RF performance and aesthetics. Compounding the problem is the requirement for laser personalization of the transaction card on or within an exposed surface or an underlying layer. A highly sophisticated appearance is a prerequisite in terms of visual aspects, vibrant colors, texture, smooth metal edges, deeply engraved logos and credentials, sufficient weight, and the drop acoustics of the card should sound like metal and not plastic. To achieve these prestige aspects in visual design, tactile effects and mechanical construction of the card, there remains the challenge to incorporate contactless functionality which meets the requirements of EMVCo with or without a waiver.

### Some Security Concerns

It is a requirement for security reasons that the transponder chip module, when inserted and adhesively attached to a metal card body, that the adhesion of the chip module is permanent and cannot be easily extracted, especially if backside spot pressure is applied to the reverse side of the chip module. The chip module should withstand a back pressure of 70 Newtons, but this depends on the adhesive and the surface to which the adhesive is applied.

### SOME REFERENCES

The following US patents and patent application publications are referenced:
U.S. Pat. No. 10,599,972 (2020 Mar. 24; Finn et al.)
U.S. Pat. No. 10,552,722 Smartcard with coupling frame antenna
U.S. Pat. No. 10,518,518 (2019 Dec. 31; Finn et al.)
U.S. Pat. No. 10,248,902 Coupling frames for RFID devices
U.S. Pat. No. 10,193,211 Smartcards, RFID devices, wearables and methods
U.S. Pat. No. 9,960,476 Smartcard constructions
U.S. Pat. No. 9,836,684 Smartcards, payment objects and methods
U.S. Pat. No. 9,697,459 Passive smartcards, metal cards, payment objects
U.S. Pat. No. 9,812,782 Coupling frames for RFID devices
U.S. Pat. No. 9,390,364 Transponder chip module with coupling frame on a common substrate
U.S. Pat. No. 9,489,613 RFID transponder chip modules with a band of the antenna extending inward
U.S. Pat. No. 9,634,391 RFID transponder chip modules
U.S. Pat. No. 9,622,359 RFID transponder chip modules
U.S. Pat. No. 9,798,968 Smartcard with coupling frame and method of increasing activation distance
U.S. Pat. No. 9,475,086 Smartcard with coupling frame and method of increasing activation distance
2018/0339503 Smartcards with metal layers and methods of manufacture
2018/0341846 Contactless metal card construction
2018/0341847 Smartcard with coupling frame antenna
2019/0114526 Smartcard constructions and methods
2019/0171923 Metallized smartcard constructions and methods
2019/0197386 Contactless smartcards with multiple coupling frames
   Analysis of some prior art with respect to Multi-layered Metal Stack-up Card Constructions

U.S. Pat. No. 9,798,968 (2017 Oct. 24; Finn et al.; Féinics AmaTech Teoranta) discloses smartcard with coupling frame and method of increasing activation distance of a transponder chip module. A conductive coupling frame (CF) having two ends, forming an open loop having two ends or a discontinuous metal layer disposed surrounding and closely adjacent a transponder chip module (TCM, 610), and substantially coplanar with an antenna structure (AS, CES, LES) in the transponder chip module (TCM). A metal card body (MCB, CB) or a transaction card with a discontinuous metal layer having a slit (S) or a non-conductive strip (NCS, 1034) extending from a module opening (MO) to a periphery of the card body to function as a coupling frame (CF). The coupling frame (CF) may be thick enough to be non-transparent to RF at frequencies of interest. A switch (SW) may be provided to connect ends of the coupling frame (CF) across the slit (S, 630). A reinforcing structure (RS) may be provided to stabilize the coupling frame (CF) and card body (CB). The transponder chip module (TCM) may comprise an antenna structure which may be a laser-etched antenna structure (LES) or a chemical-etched antenna structure (CES) and may comprise and a non-perforated contact pad (CP) arrangement. A coupling frame (CF) may be incorporated onto the module tape (MT, CCT) for a transponder chip module (TCM).

The coupling frames disclosed in U.S. Pat. No. 9,798,968 may be formed from layers of various metals (such as copper, aluminum (aluminum), brass, titanium, tungsten, stainless steel, silver, graphene, silver nanowires, conductive carbon ink), and may be in the form of ribbon cable, or the like, which could be hot stamped into a layer of the card.

The metal card or metal slug in a card body acting as the coupling frame can be made from materials such as copper, aluminum, tungsten, stainless steel, brass, titanium or a combination thereof.

The metal layer may comprise a material selected from the group consisting of copper, aluminum (aluminum), brass, titanium, tungsten, stainless steel, silver, graphene, silver nanowires and conductive carbon ink. The metal layer may be disposed on a non-conductive layer by a process selected from the group consisting of silk screen printing and vapor deposition. The metal layer may comprise a mesh. The metal layer may comprise an engraving, embossing, or stamped feature/logo/ID which serves as a security feature for the smartcard.

Coupling frames (CFs) can be made from foil metals, thickness from 9-100 μm or from bulk metal with thickness up to the total normal thickness of a smartcard (760 μm). The metal can be any metal or alloy, for example copper, aluminum, brass, steel, tungsten, titanium. The metal foil may be of any origin, e.g. electrodeposited or roll annealed. The coupling frames (CF) may be made by electroless deposition on a substrate followed by electroplating.

As an alternative to forming (such as by cutting or etching) a slit (S) is to render a comparable area of the conductive layer of the coupling frame (CF) non-conductive. One example of converting a conductive material (such as aluminum or titanium) to be non-conductive is described in US 2010/0078329. In its simplest form, electrochemical anodic oxidation of selected portions of an initially conductive valve metal (for example, aluminum, titanium, or tantalum) substrate may be performed, resulting in areas (regions) of conductive (starting) material which are geometrically defined and isolated from one another by areas (regions) of anodized (non-conductive, such as aluminum oxide, or alumina) isolation structures.

U.S. Pat. No. 9,697,459 (2017 Jul. 4; Finn et al.; Féinics AmaTech Teoranta) discloses passive smart cards, metal cards, payment objects and smart jewelry. RFID devices comprising (i) a transponder chip module (TCM, 1410) having an RFIC chip (IC) and a module antenna (MA), and (ii) a coupling frame (CF) having an electrical discontinuity comprising a slit (S) or non-conductive stripe (NCS). The coupling frame may be disposed closely adjacent the transponder chip module so that the slit overlaps the module antenna. The RFID device may be a payment object such as a jewelry item having a metal component modified with a slit (S) to function as a coupling frame. The coupling frame may be moved (such as rotated) to position the slit to selectively overlap the module antennas (MA) of one or more transponder chip modules (TCM-1, TCM-2) disposed in the payment object, thereby selectively enhancing (including enabling) contactless communication between a given transponder chip module in the payment object and another RFID device such as an external contactless reader. The coupling frame may be tubular. A card body construction for a metal smart card is disclosed.

### Some Patents and Publications of Interest

The following patents and/or publications (“references”) may be of interest or relevant to the invention(s) disclosed herein, and some commentary may be provided to distinguish the invention(s) disclosed herein from the following references.

US 2019/0114526 (18 Apr. 2019; Finn et al.; now 10,599,972; 24 Mar. 2020) discloses Smartcard Constructions and Methods, and describes smartcards having (i) a metal card body (MCB) with a slit (S) overlapping a module antenna (MA) of a chip module (TCM) or (ii) multiple metal layers (M1, M2, M3) each having a slit (S1, S2, S3) offset from or oriented differently than each other. A front metal layer may be continuous (no slit), and may be shielded from underlying metal layers by a shielding layer (SL). Metal backing inserts (MBI) reinforcing the slit(s) may also have a slit (S2) overlapping the module antenna. Diamond like carbon coating filling the slit. Key fobs similarly fabricated. Smart cards with metal card bodies (MCB). Plastic-Metal-Plastic smartcards and methods of manufacture are disclosed. Such cards may be contactless only, contact only, or may be dual-interface (contact and contactless) cards.

FIG. 20A of US 2019/0114526 is a diagram (exploded perspective view) of a “Plastic-Metal-Plastic” Card (aka Embedded Metal or Metal Core Card), before lamination. A chip module is shown for insertion into the card.

FIG. 20A of US 2019/0114526 is a diagrammatic view of a DIF “Plastic-Metal-Plastic” Card, before lamination, generally comprising (from top-to-bottom, as viewed): [0477] an 8 pin chip module 2010 which may be a transponder chip module (TCM). The chip module may be single interface (contact only), or dual interface (contact and contactless). In the latter case (dual interface), the chip module may be a transponder chip module having a module antenna. (A module antenna is not required in a contact only module.) In the main, a chip module which is a transponder chip module will be described, as exemplary. A front clear overlay (plastic) layer 2062 which may have a thickness of approximately 50 μm. A recess or opening (shown in dashed lines “module recess”) for accepting the module may be milled in this layer, after final lamination. A front (plastic) printed core layer 2064 (displaying the logo “AMATECH”) which may have a thickness of approximately 125 μm. A recess or opening (shown in dashed lines) for accepting the module may be milled in this layer, after final lamination. The front clear overlay film with adhesive backing and front printed core may be adhesively attached together in sheet format and may constitute a front (plastic) subassembly (or plastic layer assembly) 2060. A layer of adhesive 2022 which may have a thickness of approximately 20 μm. A metal layer (ML) (or metal core) 2020 which may have a thickness of approximately 400 μm and which may be provided with an opening (MO) 2008 which may be a stepped recess extending through the metal layer. The metal layer may have a slit S (or a non-conductive stripe NCS) 2030 extending from the opening to an outer edge thereof so that the metal layer may function as a coupling frame (for a contactless interface). The metal layer or core may consist of several metal layers with slits. The slit is not necessary for a contact only chip module. The recess may be stepped, having a larger portion extending 100 μm into the metal layer, for a module tape of the chip module, and a smaller portion extending the rest of the way (additional 300 μm) through the metal layer for a mold mass of the chip module. This may ensure (in the case of contactless functionality) that the coupling frame appropriately overlaps the module antenna of the transponder chip module. The metal layer (ML) may comprise two metal layers, each having a thickness of approximately 200 μm. The opening MO 2008 in the metal layer ML 2020 may be filled with a plastic slug 2026. A layer of adhesive 2024 which may have a thickness of approximately 20 μm. A rear printed core 2074 which may have a thickness of approximately 125 μm. An opening or recess for the chip module may not be required in this layer. A rear clear overlay 2072 which may have a thickness of approximately 50 μm. An opening or recess for the chip module may not be required in this layer. A magnetic stripe may be disposed on the bottom (as viewed) surface of the rear clear overlay. The rear clear overlay film with adhesive backing and rear printed core (including magnetic stripe) may be attached together and may constitute a rear (plastic) subassembly (or plastic layer assembly) 2070.

Card-size front and rear face subassemblies (plastic layer assemblies) may be pre-pressed against the adhesive layers and the metal core or coupling frame to form a card blank.

U.S. Pat. No. 9,760,816 (2017 Sep. 12; Troy et al.) discloses metal-containing transaction cards and methods of making the same. A transaction card is provided comprising a card body comprising a metallic material, the card body including a primary surface, a secondary surface, an aperture and a slit, wherein the primary surface and the secondary surface are coated with a diamond like carbon (DLC) coating.

U.S. Pat. No. 10,395,153 (2019 Aug. 27; Herslow) discloses durable card. Cards which include a core subassembly whose elements define the functionality of the card and a hard coat subassembly attached to the top and/or bottom sides of the core subassembly to protect the core subassembly from wear and tear and being scratched. The core subassembly may be formed solely of plastic layers or of different combinations of plastic and metal layers and may include all the elements of a smart card enabling contactless RF communication and/or direct contact communication. The hard coat subassembly includes a hard coat layer, which typically includes nanoparticles, and a buffer or primer layer formed so as to be attached between the hard coat layer and the core subassembly for enabling the lasering of the core subassembly without negatively impacting the hard coat layer and/or for imparting color to the card.

U.S. Pat. No. 9,569,718 (2017 Feb. 14; Herslow) discloses card with metal layer and electrostatic protection. A metal card or a hybrid metal-plastic includes an acrylic resin protective clear-coat layer and/or a “hard” nano-particle top-coat layer overlying any exposed metal surface in order to insulate the metal and reduce the likelihood of an electrostatic discharge (ESD) or a short circuit condition. In a particular embodiment the “hard” nano-particle top-coat layer overlies the clear coat layer. The dual stage protective layers which include a clear-coat layer and a top-coat ensure that the problem associated with an ESD and/or a short circuit condition is minimized. In addition, the dual stage protection imparted to a card by forming a clear-coat layer and a top-coat layer ensures that any card surface treatment or card decoration is protected over time from excessive wear or scratching due to use in conjunction with a POS device and/or handling.

US 2019/0236434 (2019 Aug. 1; Lowe; now U.S. Pat. No. 10,762,412) discloses DI capacitive embedded metal card. A transaction card having a metal layer, an opening in the metal layer for a transponder chip, and at least one discontinuity extending from an origin on the card periphery to a terminus in the opening. The card has a greater flex resistance than a card having a comparative discontinuity with the terminus and the origin the same distance from a line defined by a first long side of the card periphery in an absence of one or more strengthening features. Strengthening features include a discontinuity wherein one of the terminus or the origin are located relatively closer to the first long side of the card periphery than the other, a plurality of discontinuities wherein fewer than all extend from the card periphery to the opening, a self-supporting, non-metal layer disposed on at least one surface of the card, or one or more ceramic reinforcing tabs surrounding the opening.

US 2019/0050706 (2019 Feb. 14; Lowe) discloses over-molded electronic components for transaction cards and methods of making thereof. A process for manufacturing a transaction card includes forming an opening in a card body of the transaction card; inserting an electronic component into the opening; and molding a molding material about the electronic component. A transaction card includes a molded electronic component.

US 2018/0339503 (2018 Nov. 29; Finn et al.) discloses smartcards with metal layer(s) and methods of manufacture. Smartcards with metal layers manufactured according to various techniques disclosed herein. One or more metal layers of a smartcard stack-up may be provided with slits overlapping at least a portion of a module antenna in an associated transponder chip module disposed in the smartcard so that the metal layer functions as a coupling frame. One or more metal layers may be pre-laminated with plastic layers to form a metal core or clad subassembly for a smartcard, and outer printed and/or overlay plastic layers may be laminated to the front and/or back of the metal core. Front and back overlays may be provided. Various stack-up constructions and manufacturing techniques (including temperature, time, and pressure regimes for laminating) for smartcards are disclosed in the application.

US 2017/0098151 (2017 Apr. 6; Herslow et al.) discloses transaction and ID cards having selected texture and coloring. Cards including a specially treated thin decorative layer attached to a thick core layer of metal or ceramic material, where the thin decorative layer is designed to provide selected color(s) and/or selected texture(s) to a surface of the metal cards. Decorative layers for use in practicing the invention include: (a) an anodized metal layer; or (b) a layer of material derived from plant or animal matter (e.g., wood, leather); or (c) an assortment of aggregate binder material (e.g., cement, mortar, epoxies) mixed with laser-reactive materials (e.g., finely divided carbon); or (d) a ceramic layer; and (e) a layer of crystal fabric material. The cards may be dual interface smart cards which can be read in a contactless manner and/or via contacts.

US 2012/0325914 (2012 Dec. 27; Herslow) discloses combination card of metal and plastic. A card which includes a first assembly comprised of multiple plastic layers attached via an adhesive to a metal layer. The multiple plastic layers forming the first assembly are laminated under a first selected temperature and pressure conditions to preshrink the multiple plastic layers, stress relieve the first assembly and render the first assembly dimensionally stable. The laminated first assembly is then attached to a metal layer via an adhesive layer to form a second assembly which is then laminated at a temperature below the first selected temperature to form a card which is not subjected to warpage and delamination.

US 2010/0116891 (2018 Mar. 25; Yano et al.) discloses card-like magnetic recording medium, method for manufacturing the recording medium, laminated body for transfer and method for manufacturing the laminated body. A method to provide a card-like magnetic recording medium and a transferable laminate which can make a hologram distinctly recognizable and can prevent the occurrence of an ESD fault. In the card-like magnetic recording medium, on the magnetic recording layer 12 formed on the base material for a card 20, the transparent non-conductive deposited layer 14 and the transparent optical diffraction layer 15 are laminated in this order; between the magnetic recording layer 12 and the transparent non-conductive deposited layer 14, a reflective ink layer 13 which includes, at least, binder resin and metal flake, is formed; and a mass ratio of this binder resin/metal flake is set from 3 to 10.

FIG. 1 of US 2010/0116891 is a sectional view illustrating an example of a configuration of a card-like magnetic recording medium.

From the teachings of US 2010/0116891 (Yano et al.), this card-like magnetic recording medium is formed with an adhesive layer 11, a magnetic recording layer 12, a reflective ink layer 13, a transparent non-conductive deposited layer 14, a transparent optical diffraction layer 15, and a protective layer 16, which are laminated on a base material of a card 20, respectively.

As the material of the protective layer 16, acrylic series resin, polyester series resin, amide series resin, cellulose series resin, vinyl series resin, urethane series resin, olefin series resin, epoxy series resin, etc., can be exemplified, and the thickness is preferable in the range of 0.5 to 5 μm. But the thickness is not limited to the range.

### Some Definitions

Some of the following terms may be used or referred to, herein.

### Hard Coat Layer for Smartcards—Clear Diamond Film Layer

A hard coat layer on a release carrier layer is supplied to the smartcard industry by Crown Roll Leaf. The clear film can be hot stamped or laminated to a card body assembly, to provide a card surface finish with a high abrasion resistance and high chemical resistance. This film is designed for use on transaction cards, identification cards, transit passes and other similar cards where the film is applied on the card surface. Its high durability characteristics ensure the card information remains intact through the lifetime of the card.

The release carrier layer is made of a matte polyester film having a thickness of 23 μm.

### Print Film and Overlay Material

Print films can be opaque or clear having various thicknesses depending on the position in the card body construction, as an overlay film on the rear of the card body to capture the magnetic stripe and the security elements, or form part of the core, with the films having different surface roughness, tension and VICAT temperature depending on the application.

The base color of the print films can be different shades of white, colored, translucent or transparent. PVC films with an adhesive coating may be referred to as PVC WA. Transparent films may also be laser engravable.

### Digital Reverse UV Printing

Conventional lithographic printing on a six-color press defines the minimum thickness of a print film in the stack-up construction of a transaction card body. This minimum thickness of the print film is approximately 125 μm (5 mils). Reverse digital printing on overlay material (transparent or translucent) with a thickness of 50 μm (2 mils) significantly reduces the material thickness of the print layer, while at same time allowing for a thicker metal layer in a metal core or metal face transaction card, resulting in a heavier card.

### RFID Slit Technology

“RFID Slit Technology” refers to modifying a metal layer or a metal card body (MCB) into a so-called “antenna circuit” by providing a discontinuity in the form of a slit, slot or gap in the metal layer or metal card body (MCB) which extends from a peripheral edge to an inner area or opening in the layer or card body. The concentration of surface current at the inner area or opening can be picked up by another antenna (such as a module antenna) or an antenna circuit by means of inductive coupling which can drive an electronic circuit such as an RFID chip attached directly or indirectly thereto. The slit may be ultra-fine (typically less than 50 μm or less than 100 μm), cut entirely through the metal with a UV laser, with the debris from the plume removed by ultrasonic or plasma cleaning. Without a cleaning step after lasing, the contamination may lead to shorting across the slit. In addition, the slit may be filled with a dielectric to avoid such shorting during flexing of the metal forming the transaction card. The laser-cut slit may be further reinforced with the same filler such as a resin, epoxy, mold material, repair liquid or sealant applied and allowed to cure to a hardened state or flexible state. The filler may be dispensed or injection molded. The term “slit technology” may also refer to a “coupling frame” with the aforementioned slit, or to a smartcard embodying the slit technology or having a coupling frame incorporated therein.

Providing a metal layer in a stackup of a card body, or an entire metal card body, to have a module opening for receiving a transponder chip module (TCM) and a slit (S) to improve contactless (RF) interface with the card—in other words, a “coupling frame”—may be described in greater detail in U.S. Pat. Nos. 9,475,086, 9,798,968, and in some other patents that may be mentioned herein. In some cases, a coupling frame may be formed from a metal layer or metal card body having a slit, without having a module opening. A typical slit may have a width of approximately 100 μm, and may be referred to as a “narrow slit”. As may be used herein, a “micro-slit” refers to a slit having a smaller width, such as approximately 50 μm, or less.

### Security Inks

By definition, ink does not require color. While dyes and pigments are what give ink its color in most applications, the same dyes and pigments can be formulated to be naked to the visible eye for security applications. Because invisible ink does not have color by design, most applications of invisible security ink involve a taggant that reacts with a specially designed camera, light, or scanner. When implementing security ink, the taggant is developed to react only with proper equipment using a UV, infrared, or near-infrared light at a specific wavelength.

Therefore, security inks may have the following properties:
Invisible fluorescent
Visible fluorescent
Ultraviolet invisible
IR invisible
UV longwave and shortwave
Lightfast and non-lightfast

Photosensitive ink is visible to the naked eye but changes color or disappears when placed under a UV light.

### Screen Printing, Mist-Coating or Spraying a Lacquer

The alternative to applying a film to a card body assembly or subassembly is screen printing, mist-coating, spraying or curtain coating an acrylic, enamel or lacquer to the surface requiring a protective layer. Such liquid medium may be transformed into a hard coat by the application of heat, typically in an oven.

### Digital Printing of Ultra-Violet Ink

UV printing is a form of digital printing that uses ultra-violet light to dry or cure ink as it is printed. As the printer distributes ink on the surface of a material (called a “substrate”), specially designed UV lamps follow close behind, curing—or drying—the ink instantly. A primer coat may be used to prime the substrate surface to enhance adhesion.

UV-flexible ink is a liquid which consists of monomers, colorant, additives, photoinitiator and stabilizer. UV hard ink comprises for example of the following elements: acryl acid ester, 1,6-hexanediol diacrylate initiator, additive and quinacridone series pigment. The primer is made up of aliphatic monomer, acrylic oligomer, aromatic monomer, additives and photoinitiator.

### Polyethylene Naphthalate (PEN)

It is a high-performance, crystal clear thermoplastic made from naphthalene-2,6-dicarboxylic acid and ethylene glycol. PEN has many attractive properties including high tensile strength, low heat shrinkage, excellent dimensional stability, low moisture absorption, and good retention of physical properties over a fairly wide temperature range. Its oxygen barrier, hydrolytic stability, and tensile strength surpass those of PET films. It also has superior UV resistance, excellent electrical properties, much lower heat shrinkage, good optical clarity and high gloss but only moderate moisture barrier properties. It has a relative high melting point and glass transition temperature (120° C.), which makes it suitable for applications that require sterilization at high temperatures. Typical grades have a continuous service temperature of about 160° C.

### Thermosetting Resin

A thermosetting resin, or thermoset, is a polymer which cures or sets into a hard shape using curing method such as heat or radiation. The curing process is irreversible as it introduces a polymer network crosslinked by covalent chemical bonds.

Upon heating, unlike thermoplastics, thermosets remain solid until temperature reaches the point where thermoset begins to degrade.

Phenolic resins, amino resins, polyester resins, silicone resins, epoxy resins, and polyurethanes (polyesters, vinyl esters, epoxies, bismaleimides, cyanate esters, polyimides and phenolics) are few examples of thermosetting resins.

### Thermoset Adhesives

Thermoset adhesives are crosslinked polymeric resins that are cured using heat and/or heat and pressure. They represent a number of different substances that undergo a chemical reaction when curing, such that the structure formed has superior strength and environmental resistance. Despite their name, thermosets may or may not require heat to cure and may instead use irradiation or electron beam processing. Due to their superior strength and resistance, thermosets are widely used for structural load-bearing applications.

Thermoset adhesives are available as one- or (more commonly) two-component systems. One component systems use heat curing and require cold storage for sufficient shelf life. Most one component adhesives are sold as pastes and applied by a trowel to easily fill gaps.

Two component systems must be mixed and applied within a set time frame, ranging from a few minutes to hours. Two component epoxies are suitable for bonding nearly all substrates and feature high strength and chemical resistance as well as excellent long-term stability.

### B-Staged Epoxy Resin

It is a descriptive term used to define a one component epoxy system, using a latent (low reactivity) curing agent. This unique product can be partially cured (sometimes referred to as “pre-dried”), as an initial stage after being applied onto one substrate/surface. It can, at a later time, be completely cured under heat and pressure.

Partially cured epoxy, or B-staged epoxy adhesive, does have processing advantages. The adhesive can have its initial application and partial cure in one location, and its final cure in another location weeks later.

### C-Staged Epoxy Resin

The B stage is a solid, thermoplastic stage. When given additional heat, the B-stage epoxy will flow and continue to cure to a crosslinked condition or C stage.

### Laser Ablation or Photoablation

It is the process of removing material from a solid surface by irradiating it with a laser beam. At low laser fluence, the material is heated by the absorbed laser energy and evaporates or sublimates. At high laser fluence, the material is typically converted to a plasma. Usually, laser ablation refers to removing material with a pulsed laser, but it is possible to ablate material with a continuous wave laser beam if the laser intensity is high enough. In laser treating polymers and coated metal surfaces, one needs to distinguish between photochemical and photothermal ablation.

### Laser Engraving

Laser engraving is an alternative technique to using tool bits which contact the engraving surface. It is a subset of laser marking, the practice of using lasers to engrave an object. The impact of laser marking has been more pronounced for specially designed “laserable” materials and also for some paints. These include laser-sensitive polymers such overlay material and novel metal alloys.

Finely polished metal sheets coated with enamel paint can be ablated using a laser. At levels of 10 to 30 watts, engravings are made as the enamel is removed or vaporized cleanly from the surface.

Anodized aluminum is commonly engraved or etched with CO₂ laser machine. With power less than 40 W this metal can easily be engraved with clean, impressive detail. The laser bleaches the color exposing the white or silver aluminum substrate.

Spray coatings can be obtained for the specific use of laser engraving metals, these sprays apply a coating that is visible to the laser light which fuses the coating to the substrate where the laser beam passed over. Typically, these sprays can also be used to engrave other optically invisible or reflective substances such as glass and are available in a variety of colors.

Laserability of Cards which includes a Metal Layer, as presented in U.S. Pat. No. 10,395,153

This process shows good contrast and is very secure since the hard coat layer can be ablated down to the bare surface of the underlying metal. Note the hard coat layer is either ablated if it is in direct contact with the metal surface or unaffected (if adhesive and plastic layers are attached to the metal surface) depending upon how the print and background qualities of the card affect the laser beam reflection and absorption. Sometimes, with a powerful laser the surface of the metal may also be affected causing bright bare metal to remain.

### SUMMARY

The invention may relate to some improvements in the manufacturing, performance and/or appearance of smartcards (also known as transaction cards), such as metal transaction cards and, more particularly, to RFID-enabled smartcards (which may be referred to herein simply as “cards”) having at least contactless capability, including dual interface (contactless and contact) smartcards, including cards having a metal layer in the stackup of their card body, and including cards having a card body which is substantially entirely formed of metal (i.e., a metal card body).

According to the invention, generally, an RFID metal face transaction card may comprise of a front face metal layer (thin) with a micro-slit (˜50 μm) which may be color printed or color coated and its surface protected by a laser-reactive diamond coat. The laser-reactive diamond coat may be a protective coating (ink, varnish or a polymer coating) having several layers or a hard top-coat lamination film. The color and diamond coat may camouflage the presence of the micro-slit. The front face metal layer may be further strengthen by a supporting metal layer (thick) with a narrow slit (˜100 μm). The two metal layers may be separated by a PEN dielectric with a thermosetting epoxy on both sides which has been cured to an irreversible state (C-stage) after the lamination process. The module opening (P2) in the supporting metal layer may have a shape and geometry which matches the shape and geometry of the module antenna. The module opening (P1) in the front face metal layer may have an alignment feature (referred to as guiding or alignment post, GP) for correct alignment. The shape of the P1 and P2 openings may be polygonal in form. The insertion of the transponder chip into a module pocket after milling the P1 and P2 openings and using a heat and pressure activate adhesive tape layer for attachment, may result because of dimensional tolerances in the transponder chip module residing on the dielectric layer, on the c-stage adhesive layer or on the supporting metal layer, with no degradation in the bond strength of the attachment. The surface of the metal layers with slit and their edges may be provided with an insulating medium such as an oxide layer or a non-conductive diamond-like-carbon coating, to ensure that the problem associated with an ESD event and/or a slit short circuit condition is minimized.

According to some embodiments (or examples) of the invention, an RFID-enabled metal face transaction card may comprise: a first metal layer (ML1; 1030) with a first module opening (P1); a second metal layer (ML2; 930) with a second module opening (P2; 914); wherein: the second module opening has a shape and geometry which matches the shape and geometry of a module antenna (MA; 912, 1012) of a transponder chip module (TCM; 910, 1010) which will be inserted into the card. The first module opening may have an alignment feature (GP; 1016) for ensuring correct alignment of a transponder chip module (TCM) inserted into the opening. At least one of the first and second module openings may have a polygonal shape which matches the shape of the module antenna, with a size that allows for the module antenna to at least partially overlap the metal layer outside of the module opening.

The second metal layer may be at least approximately twice as thick as the first metal layer. The first metal layer has a first slit (S1); and a second metal layer has a second slit (S2) which may be wider than the first slit. The slits (S1, and S2) may be aligned offset, nearly one over the other, so as to be as close as possible without overlapping each other, so that the metal of one metal layer supports the slit of the other metal layer.

A polymeric carrier layer which is a PET or PEN dielectric layer with thermosetting epoxy on both sides may be disposed between the first and second metal layers. Importantly, the thermosetting epoxy is cured to an irreversible state (C-stage) when it is laminated with the first and second metal layers.

A transparent, translucent, white, or colored print layer may be disposed behind the second metal layer; and a laser-reactive overlay layer may be disposed behind the transparent print layer.

A transponder chip module (TCM) may be disposed in the first and second module openings. The chip module may have contact pads to function as a dual-interface module.

According to some embodiments (or examples) of the invention, an RFID-enabled metal face transaction card may comprise: a first metal layer (ML1, 830) having a first slit (S1, 820a); a second metal layer (ML2, 840) having a second slit (S2, 820b); wherein: the first metal layer is thin, having a thickness of approximately 100-160 μm, and serves as a front face of the card; and the second metal layer is approximately twice as thick as the first metal layer, having a thickness of approximately 300-350 μm, and supports the first metal layer. The first slit may be a micro-slit having a width of approximately 50 μm; and the second slit may be a narrow slit having a width of approximately 100 μm. The first slit may be offset from the second slit, yet the two slits may be located as close to one another as possible, without overlapping (one directly atop the other).

Color printing or a coating (826) may be disposed over the first slit to disguise or camouflage the first slit. A laser-reactive diamond coat (824) may be disposed on a surface of the first metal layer; wherein the laser-reactive diamond coat comprises a protective coating having several layers of ink, varnish or a polymer coating, or a hard top-coat lamination film; and wherein the laser-reactive diamond coat protects the first metal layer and disguises or camouflages the first slit.

A polymeric carrier layer which is a PET or PEN dielectric layer (835) with thermosetting epoxy on both sides may be disposed between the first and second metal layers. The thermosetting epoxy may be cured to an irreversible state (C-stage) when laminated with the first and second metal layers.

A transparent, translucent, white, or colored print layer (850) with printed information (PI) comprising primer and ink may be disposed behind the second metal layer; and an adhesive layer (845) of thermosetting epoxy disposed between the second metal layer and the transparent print layer. The print layer may have a thickness of approximately 152 μm. The adhesive layer may have a thickness of approximately 25 μm. A laser-reactive overlay layer (860) may be disposed behind the transparent print layer. The laser-reactive overlay layer may have a thickness of approximately 64 μm. At least one of a magnetic stripe (864) and security elements may be disposed on the overlay layer. Information (866) may be inscribed by a laser into or onto the laser-reactive overlay layer.

A first module opening (P1; 812) may be disposed in the first metal layer; a second module opening (P2; 814) may be disposed in the second metal layer; and a transponder chip module (TCM; 810) may be disposed in the first and second module openings. A layer (811) of adhesive, the size of the transponder chip module, may be disposed on an underside of the chip module. The transponder chip module may have contact pads so that it may function as a dual-interface module.

According to some embodiments (or examples) of the invention, a method of making an RFID-enabled metal face transaction card may comprise: providing a first metal layer (ML1; 830) with a first slit (S1; 820a); providing a second metal layer (ML2; 840) with a second slit (S2; 820b); providing a dielectric layer (835) between the first and second metal layers; providing a transparent, translucent, white or colored print layer (850) below the second metal layer; providing an adhesive film layer (845) between the print layer and the second metal layer; and providing a laser-reactive diamond coat (824) on a surface of the first metal layer; wherein the laser-reactive diamond coat comprises a protective coating having several layers of ink, varnish or a polymer coating, or a hard top-coat lamination film; and wherein the laser-reactive diamond coat protects the first metal layer and disguises or camouflages the first slit. A laser-reactive overlay layer (860) may be disposed below the print layer.

The dielectric layer between the two metal layers may comprise: a layer (834) of PET or PEN with thermosetting epoxy adhesive (832) on both sides thereof.

A transponder chip module (TCM; 810) with a layer of adhesive (811), the size of the transponder chip module, disposed on an underside of the chip module, may be disposed in module openings (MO1, MO2) in the two metal layers (ML1, ML2). Prior to inserting the transponder chip module into the card, a first module opening (MO, P1) may be milled in the first metal layer (ML1), and a second module opening (MO, P2) may be milled in the second metal layer (ML2)

According to some embodiments (or examples) of the invention, a method of making an RFID-enabled metal face transaction card may comprise: providing a first metal layer (ML1, 830) having a first module opening (“P1”; 812) and a first slit (S1, 820a); providing a second metal layer (ML2, 840) having a second module opening (“P2”; 814) and a second slit (S2, 820b); and

providing a dielectric layer (835) between the first and second metal layers; and may be characterized by: providing at least peripheral portions of the first and second metal layers, and their slits, and their outer edges with an insulating medium such as an oxide layer or a non-conductive diamond-like-carbon coating, to ensure that the problem associated with an ESD event and/or a slit short circuit condition is minimized.

A PET or PEN dielectric layer (834) with thermosetting epoxy (832) on both sides thereof may be disposed between the first and second metal layers.

A transponder chip module (TCM; 810) may be disposed in the first and second module openings. The chip module may have contact pads so that it may function as a dual-interface (contact and contactless) module.

It is an object of the invention to manufacture RFID enabled metal transaction cards formed with at least one metal layer having a slit or reinforced slit attached to at least one plastic layer, and to simplify the material lamination process.

It is an object of the invention to mechanically engrave a logo (e.g. issuing bank or payment scheme logo) in a color printed or coated metal layer protected by a scratch resistant synthetic layer (transparent overlay layer) or a protective coating (ink, varnish or a polymer), without damaging its surface. In addition, the synthetic layer or coating should allow the passage of a laser beam without thermal degradation of the material or coating, so as to enable laser marking or etching of the metal for personalization purposes.

It is an object of the invention to have different slit designs enabling contactless communication in metal core or metal face transaction cards which combine EMV performance and mechanical stability of the card body. In the case of a metal face transaction card having a front face metal layer with a slit mechanically supported by an underlying metal layer with a slit, the shape and width of the slit on each metal layer may differ, with the front face metal layer having a micro slit (˜50 μm) and the supporting metal layer having a narrow slit (˜100 μm). Security elements such as invisible ink may be digitally or screen printed to a synthetic layer in the card body.

Two “types” of transaction cards may be described herein:
metal core transaction cards having front and rear plastic layers; and
metal face transaction cards having only a rear plastic layer.

According to the invention, generally, an RFID metal transaction card may comprise multiple layers attached to a metal layer with slit acting as a coupling frame for contactless communication, and providing durability and aesthetics at a reduced cost and increased efficiency. The slit in the metal layer may be reinforced. The metal layer with slit may be color printed or coated and its surface protected by a laser-reactive diamond coat (protective coating (ink, varnish or a polymer) or a hard coat lamination film on a release carrier layer).

The colored or printed coated metal layer with a laser-reactive diamond coat may be mechanically engraved with a logo, removing the diamond coat and exposing the metal. The colored coated metal layer with diamond coat may be further laser marked or etched to personalize the transaction card with the credentials of the card holder. The metal layer with slit may be supported by an underlying layer of fiberglass, carbon fiber or rigid textile. The slit can be filled with a UV curing epoxy or a two-component adhesive, dispensed as a microfluidic droplet for in situ bonding of the slit under pressure and vacuum control. The transaction card may include printed security features using invisible inks. The adhesive system used to bond the layers (metal and plastic) in the stack-up construction do not dampen to any great degree the metal sound of the card.

The invention may relate to innovations in or improvements to RFID enabled metal smartcards or metal transaction cards with ESD protection.

It is an object of the invention to provide solid metal cards and or metal-containing cards (i.e., cards having at least one metal layer and at least one plastic layer) with electrostatic discharge (ESD) and/or slit short circuit protection. Short circuit protection may relate to a situation where the slit in a metal layer becomes short-circuited, and may also refer to a situation where two metal layers with slits (i.e., coupling frames) become short-circuited with one another.

According to some embodiments of the invention, a transaction card may comprise:
a layer or several layers of non-magnetic electrically conductive material with a slit to function as a coupling frame, having an inner surface and outer surface, said inner and outer surfaces being generally planar and parallel to each other;
an assembly of electrically non-conductive material attached to the inner surface of the layer or layers of non-magnetic electrically conductive material; and
an electrically non-conducting protective layer overlying said outer surface for preventing said outer surface from making direct contact with any other surface; and wherein said protective layer forms the outer layer of the card and includes the following:
(a) a plastic overlay layer to provide electrical insulation to any surface it overlies;
(b) a hard top-coat lamination film layer of electrically non-conductive material in direct contact with and overlying the plastic overlay layer to provide both additional electrical insulation and protection against wear and tear and scratching to any surface it overlies, and
(c) optionally, an insulating coating on the exposed edges of the non-magnetic electrically conductive layer or layers with slit; and wherein said plastic overlay layer and said hard top-coat lamination film layer form the two outer protective layers of said transaction card.

The laser-reactive hard top-coat lamination film layer and the laser-reactive overlay layer may be replaced by a layer or several layers of protective coating (ink, varnish or a polymer) which can be laser marked, engraved or provided with thin film effects. The coating may be transparent, have a pigment, or have nanoparticles to promote the laser treatment process.

The non-magnetic electrically conductive material may have a baked-on-ink layer or a pigment coated color layer which is electrical non-conducting, and hence creating a three-fold protection against an electrical discharge.

According to some embodiments of the invention, dual stage protective layers may include (i) a plastic overlay layer and (ii) a top-coat film layer. Optionally, the edges of the metal surface may be coated with an insulating medium such as an oxide layer or a diamond-like-carbon layer, to insulate the outer edges (or perimeters) of the metal layers to minimize problems associated with an ESD event and/or a short circuit condition.

Additionally, the dual stage protection and insulated perimeter metal edges imparted to a transaction card by forming a plastic overlay layer and a top-coat film layer ensures that any card surface treatment or card decoration is protected over time from excessive wear or scratching due to use in conjunction with a POS terminal and/or general handling.

Generally, any dimensions set forth herein are approximate, and materials set forth herein are intended to be exemplary. Conventional abbreviations such as “cm” for centimeter”, “mm” for millimeter, “μm” for micron, and “nm” for nanometer may be used.

The concept of modifying a metal element of an RFID-enabled device such as a smartcard to have a slit (S) to function as a coupling frame (CF) may be applied to other products which may have an antenna module (AM) or transponder chip module (TCM) integrated therewith, such as watches, wearable devices, and the like.

Some of the features of some of the embodiments of RFID-enabled smartcards may be applicable to other RFID-enabled devices, such as smartcards having a different form factor (e.g., size), ID-000 (“mini-SIM” format of subscriber identity modules), keyfobs, payment objects, and non-secure NFC/RFID devices in any form factor

The RFID-enabled cards (and other devices) disclosed herein may be passive devices, not having a battery and harvesting power from an external contactless reader (ISO 14443). However, some of the teachings presented herein may find applicability with cards having self-contained power sources, such as small batteries (lithium-ion batteries with high areal capacity electrodes) or supercapacitors.

The transponder chip modules (TCM) disclosed herein may be contactless only, or dual-interface (contact and contactless) modules.

In their various embodiments, the invention(s) described herein may relate to payment smartcards (metal, plastic or a combination thereof), electronic credentials, identity cards, loyalty cards, access control cards, and the like.

Other objects, features and advantages of the invention(s) disclosed herein may become apparent in light of the following illustrations and descriptions thereof.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be stylized, simplified or exaggerated, others may be omitted, for illustrative clarity.

Although the invention is generally described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

Some elements may be referred to with letters (“AS”, “CBR”, “CF”, “MA”, “MT”, “TCM”, etc.) rather than or in addition to numerals. Some similar (including substantially identical) elements in various embodiments may be similarly numbered, with a given numeral such as “310”, followed by different letters such as “A”, “B”, “C”, etc. (resulting in “310A”, “310B”, “310C”), and may collectively (all of them at once) referred to simply by the numeral (“310”).

FIG. 1 (compare FIG. 1 of 62/936,453; FIG. 1 of U.S. Pat. No. 10,583,683) is an exploded perspective view of a payment card with a body having a plurality of layers, according to the prior art.

FIG. 2 (compare FIG. 2 of 62/936,453; FIG. 2C of U.S. Pat. No. 8,672,232) is a simplified cross-sectional diagram of an assembly combining a first plastic assembly with a metal layer and with printed information added to the metal and plastic layers, according to the prior art.

FIG. 3A (compare FIG. 1 of 62/925,255; FIG. 3 of U.S. Pat. No. 9,569,718) is a simplified cross-sectional diagram illustrating the addition of a clear coat layer overlying the external surface of the metal layer, according to the prior art.

FIG. 3B (compare FIG. 1A of 62/925,255; FIG. 3A of U.S. Pat. No. 9,569,718) is a simplified cross-sectional diagram illustrating the addition of clear coat layers overlying the external top and bottom surfaces of a card assembly, according to the prior art.

FIG. 3C (compare FIG. 1B of 62/925,255; FIG. 3B of U.S. Pat. No. 9,569,718) is a simplified cross-sectional diagram illustrating the addition of a single hard top-coat layer overlying the external surface of the metal layer, according to the prior art.

FIG. 3D (compare FIG. 2 of 62/925,255 filed 24 Oct. 2019 (FCS 004)) (FIG. 4 of U.S. Pat. No. 9,569,718) is a simplified cross-sectional diagram illustrating the addition of a clear coat layer overlying the exposed surface of a metal layer and a first hard top coat layer overlying the clear coat layer and a second hard top coat layer overlying the exposed surface of the top plastic layer of the card assembly, according to the prior art.

FIG. 3E (compare FIG. 2A of 62/925,255) (FIG. 4A of U.S. Pat. No. 9,569,718) is a simplified cross-sectional diagram illustrating the addition of clear coat layers and hard top-coat layers to a card assembly, according to the prior art.

FIG. 4A (compare FIG. 3 of 62/936,453) is an exploded perspective view of an RFID enabled metal core transaction card with a body having a plurality of layers, according to an embodiment of the invention.

FIG. 4B (compare FIG. 4 of 62/936,453) is an exploded perspective view of an RFID enabled metal face transaction card with a body having a plurality of layers, according to an embodiment of the invention.

FIGS. 5A-5F (compare FIGS. 5-10 of 62/936,453) are front elevation views of some RFID enabled metal transaction cards with different shaped slits and different shaped module opening, according to some embodiments of the invention.

FIG. 6 (compare FIG. 3 of 62/925,255) is a simplified cross-sectional diagram of a card stack-up construction illustrating protective anti-scratch layers sandwiching a metal layer with a slit (not shown) and intermediate plastic layers, according to an embodiment of the invention. Compare FIG. 3E.

FIG. 7A (compare FIG. 4 of 62/925,255) is a simplified isometric diagram of a transaction card with a metal layer or layers having a slit to act as an antenna with its perimeter edges having a diamond-like-carbon coating (DLC), according to an embodiment of the invention. Compare FIGS. 6, 6A of U.S. Pat. No. 9,569,718.

FIG. 7B is top view of a metal layer (without slit) in ID-1 format showing the non-conductive diamond-like-carbon coating around the perimeter edge of the card body, according to an embodiment of the invention.

FIG. 8A is a simplified cross-sectional diagram of a metal face smartcard assembly for manufacturing a metal transaction card that can be personalized on the front and rear surfaces using a laser beam and having offset positioned slits of different widths on each metal layer, according to an embodiment of the invention.

FIG. 8B is a diagram (exploded perspective view) of a metal face smartcard with offset positioned slits commencing and terminating at different positions as to those presented in FIG. 8A, according to an embodiment of the invention.

FIG. 8C is a diagram (exploded perspective view) of a transponder chip module showing the contact pads on the face up side and the module antenna with bonding pads on the face down side, including the adhesive tape layer for assembly of the module in a module pocket or cavity in a metal smartcard body, according to an embodiment of the invention.

FIG. 8D is a cross-sectional diagram of the material layers in a metal face transaction card with a stepped module opening to accept the insertion of a transponder chip module, according to an embodiment of the invention.

FIG. 9A is a diagram of a 15-turn module antenna having a polygonal shape on the rear side of a transponder chip module showing a P2 module opening in a metal layer having a slit to function as a coupling frame, according to an embodiment of the invention.

FIG. 9B is a detailed modified diagram of FIG. 9A showing the 15-turn module antenna having a polygonal shape on the rear side of a transponder chip module and illustrating the layout and geometry of its windings with top angled corner regions and bottom curved corner regions, according to an embodiment of the invention.

FIG. 10A is a top view of a “P1” opening in a front face metal layer of a metal card body with at least one guiding or aligning post and curved corners to accept the insertion of a transponder chip module having a matching shape and geometry as the P1 opening, and to receive the transponder chip module in said opening (recess, cavity or pocket) in the correction orientation and to lock snugly in position to facilitate optimum coupling of the module antenna on the rear side of the transponder chip module with an underlying metal layer or supporting metal layer having the P2 opening, according to an embodiment of the invention.

FIG. 10B is a top view of a “P2” opening in an underlying metal layer or supporting metal layer of a metal card body having a polygonal shape to match the shape of the module antenna with top angled corner regions and bottom curved corner regions, according to an embodiment of the invention.

### DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein.

Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

Reference may be made to disclosures of prior patents, publications and applications. Some text and drawings from those sources may be presented herein, but may be modified, edited or commented to blend more smoothly with the disclosure of the present application.

### Some Generic Characteristics

The smartcards described herein may have the following generic characteristics:
The card body may have dimensions similar to those of a credit card. ID-1 of the ISO/IEC 7810 standard defines cards as generally rectangular, measuring nominally 85.60 by 53.98 millimeters (3.37 in ×2.13 in).
A chip module (RFID, contact type, or dual interface) may be implanted in a recess (cavity, opening) in the card body. The recess may be a stepped recess having a first (upper, P1 portion) having a cavity depth of 250 μm, and a second (lower, P2 portion) having a cavity depth of (maximum) 600 μm.
A contact-only or dual interface chip module will have contact pads exposed at a front surface of the card body.
ISO 7816 specifies minimum and maximum thickness dimensions of a card body: Min 0.68 mm (680 μm) to Max 0.84 mm (840 μm) or Min 0.027 inch to Max 0.033 inch

Generally, any dimensions set forth herein are approximate, and materials set forth herein are intended to be exemplary. Conventional abbreviations such as “cm” for centimeter”, “mm” for millimeter, “μm” for micron, and “nm” for nanometer may be used.

The concept of modifying a metal element of an RFID-enabled device such as a smartcard to have a slit (S) to function as a coupling frame (CF) may be applied to other products which may have an antenna module (AM) or transponder chip module (TCM) integrated therewith, such as watches, wearable devices, and the like.

Some of the features of some of the embodiments of RFID-enabled smartcards may be applicable to other RFID-enabled devices, such as smartcards having a different form factor (e.g., size), ID-000 (“mini-SIM” format of subscriber identity modules), keyfobs, payment objects, and non-secure NFC/RFID devices in any form factor

The RFID-enabled cards (and other devices) disclosed herein may be passive devices, not having a battery and harvesting power from an external contactless reader (ISO 14443). However, some of the teachings presented herein may find applicability with cards having self-contained power sources, such as small batteries (lithium-ion batteries with high areal capacity electrodes) or supercapacitors.

The transponder chip modules (TCM) disclosed herein may be contactless only, or dual-interface (contact and contactless) modules.

In their various embodiments, the invention(s) described herein may relate to payment smartcards (metal, plastic or a combination thereof), electronic credentials, identity cards, loyalty cards, access control cards, and the like.

FIG. 1 shows a body (116) with a plurality of layers (102, 104, 106, 108, 110, 112, 114) that are combined to form a transaction card (100), also referred to as a payment card (100). More particularly, the layers (102, 104, 106, 108, 110, 112, 114) forming the payment card (100) include a bottom and top overlay (102, 114), a bottom and top print layer (104, 112), a bottom and top bonding layer (106, 110), and a central metal layer (108). The payment card (100) thus has seven layers (102, 104, 106, 108, 110, 112, 114), although alternative numbers of layers, such as more or less layers, may be applied.

The overlay layers (102, 114) may be a plastic or other clear bondable material, such as a laser engravable polyvinyl chloride having a thickness of about approximately 0.003 inches (˜75 μm). The print layers (104, 112) may be a plastic or paper material that can accept various types of printed words, images, and colors, and may be, for example, a polyvinyl chloride having a thickness of approximately 0.006 inches (˜150 μm). The bonding layers (106, 110) may be a plastic or adhesive layer such as, for example, polyethylene terephthalate, having a thickness of around 0.003 inches (˜75 μm). The metal layer (108) may be a metal of any suitable type such as, for example, tempered 301 stainless steel, titanium, aluminum, or other metals that provide durability and aesthetics, having a thickness of approximately 0.01 inches (˜250 μm). The layers (102, 104, 106, 108, 110, 112, 114) are selected and arranged as shown so that during a heated and pressurized lamination process, each layer (102, 104, 106, 108, 110, 112, 114) will be bound to any other transversely adjacent layer (102, 104, 106, 108, 110, 112, 114). For example, the overlay (102), when heated and cooled, will bind to the print layer (104), while the bonding layer (106) will bind to the print layer (104) and the metal layer (108), and so on. The resulting layered payment card (100) will be durable, resistant to delamination, and have a thickness of between approximately 0.027 inches (˜685 μm) and approximately 0.033 inches (˜838 μm). More particularly, such thickness may be between approximately 0.032 inches (˜812 μm) and approximately 0.033 inches (˜838 μm). In addition, such thickness may be increased in cases of a PLV finish to payment card (100).

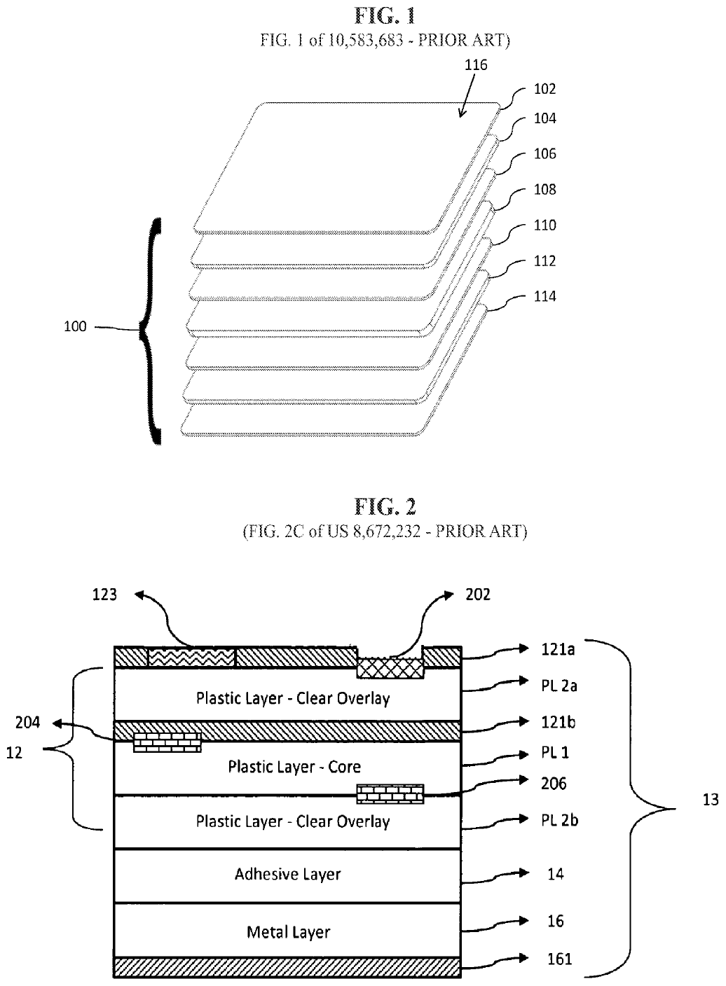

FIG. 2 is intended to show that after lamination of the second assembly 13 an outer surface or region 161 of metal layer 16 may be etched, embossed or engraved (coined and debossed) with any personalized information or decorated with any pattern. In addition, FIG. 2 is intended to show that an offset printed layer 121a may be attached or formed on the outer surface of plastic layer PL2a. As noted above, a magnetic stripe 123 may also be attached to the outer surface of layer PL2a.

Referring to FIG. 2, there is shown a contact chip 202 placed within the top region of plastic layer PL2a by forming a cavity on, and within, the outer surface of plastic layer PL2a of the card. A cavity may be formed by milling or any other suitable process and inserting a contact chip within the cavity. The contact chip will generally be flush with the plastic surface and can be visible, although it could also be placed along the outer surface of layer PL2a. The contact chip 202 is typically added after the card is finished, but it can be inserted or placed before or after the lamination processes of the first and second assemblies. A second assembly 13 of a “metal-plastic” card with contact and RFID chips could be as shown in FIG. 2.

For a card whose thickness is approximately 0.03 inches, the cumulative thickness of the layers forming the first “plastic” assembly layer can range from 0.005 to 0.025 inches. The adhesive layer may range from 0.0005 to 0.005 inches and the metal layer thickness may range from 0.008 to 0.025 inches.

A card may be made such that it is essentially half metal and half plastic. However, it should be evident that the thickness ratio of metal to plastic may be greatly varied. Also, the thickness of the card may be greater or less than 0.03 inches.

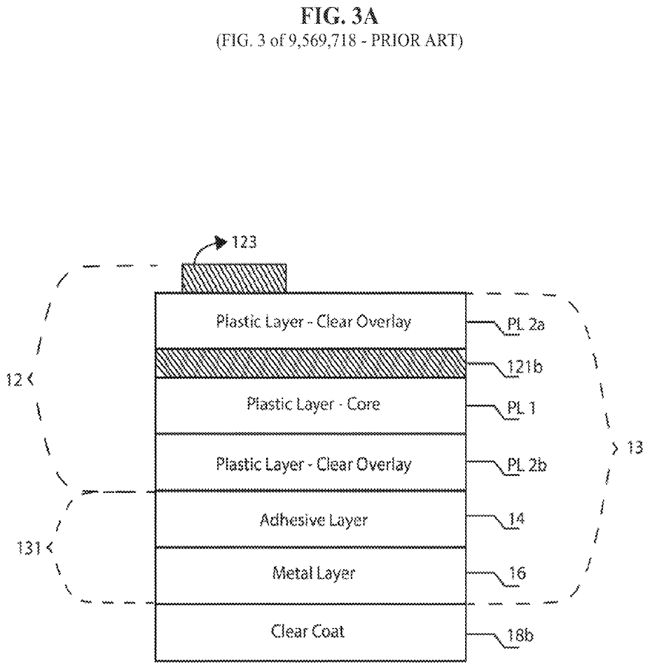

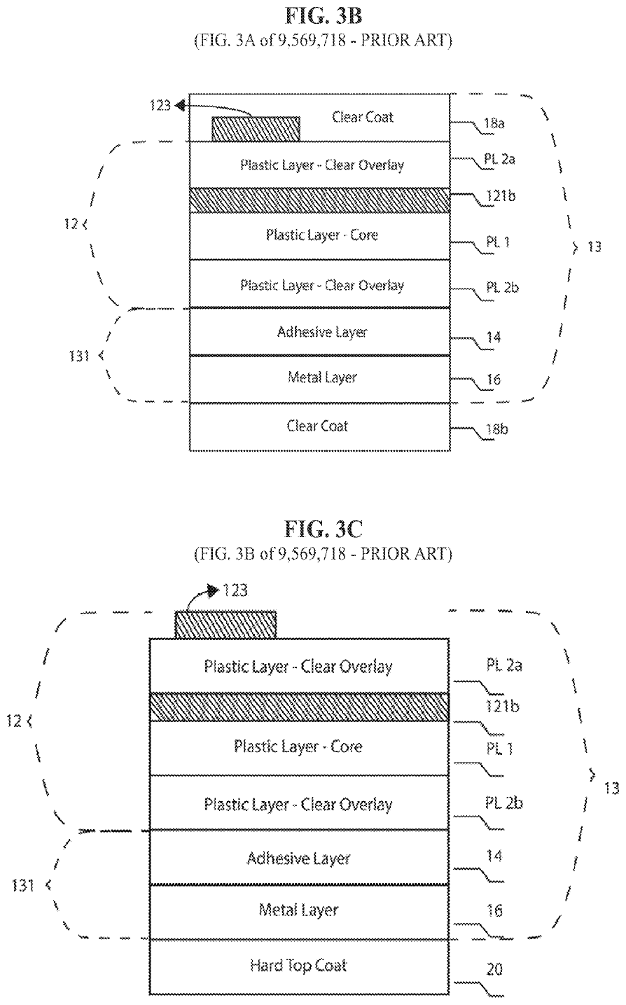

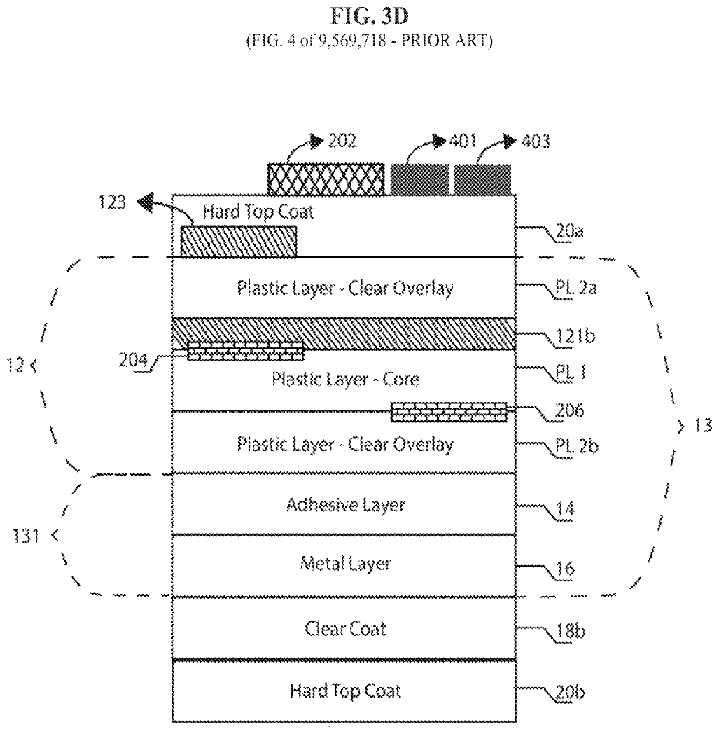

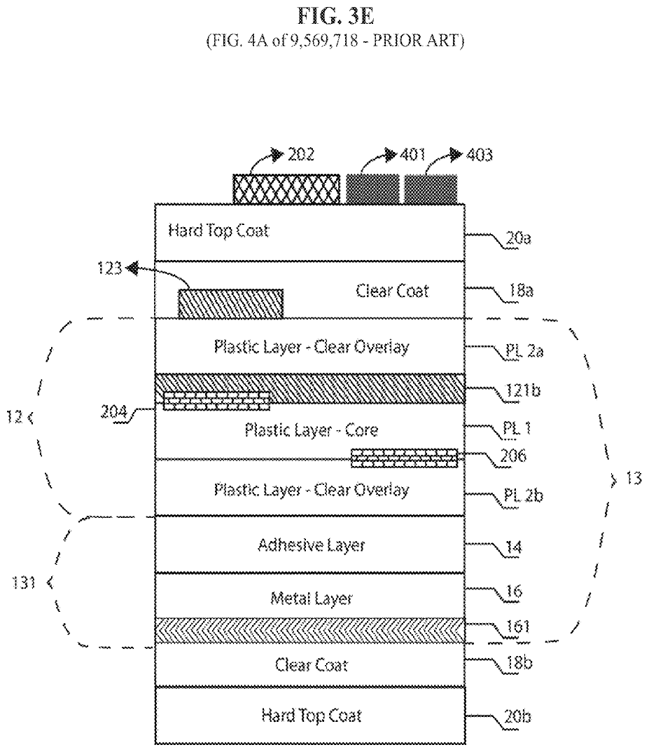

FIG. 3A shows that a clear coat resin layer 18b is attached or applied to the outer surface of metal layer 16. The clear coat layer 18b insulates the metal layer and prevents it from directly contacting any other surface. Thus, it functions to insulate the surface of the metal layer from making contact with a POS device (when a card containing the metal layer is inserted therein or withdrawn therefrom) thereby preventing ESD and/or short circuit conditions.

FIG. 3B shows a clear coat resin layer 18b is applied to the surface of the metal layer 16 and a like clear coat layer is shown applied to the top surface of plastic overlay layer PL2a which produces a symmetrical structure.

The clear coat layer (18a, 18b) may be formed of an acrylic resin (i.e., any of numerous thermoplastic or thermosetting polymers or copolymers of acrylic acid, methacrylic acid, any esters of these acids, or acrylonitrile), ultra violet (UV) curable resin blend including polyester, urethane, diol and carboxyl acrylates with ceramic particles, multifunctional acrylate polymers or any like material. The clear coat resin layer may be applied (or formed) by spraying, screen printing, painting, powder coating or any other like method, and cured (processed) by UV cure, electron beam curing, oven heat, or any radiation curing method or in any other suitable manner. The thickness of each one of the clear coat resin layers may range from 3 microns to 25 microns, or more. The minimum thickness is to ensure that the metal layer is fully covered.

FIG. 3C illustrates that a “hybrid” card can be made with a single hard top coat layer 20 overlying the external, exposed, surface of metal layer 16. This layer 20 can provide electrical insulation and abrasion protection for the underlying metal layer. Thus, either a single clear coat or a single hard coat layer may be used to insulate the external, exposed, surface of metal layer 16.

FIGS. 3D and 3E show a clear coat layer 18b overlying the metal layer 16 and a “hard” top-coat layer 20b which overlies the clear coat layer 18b. The top-coat layer 20b functions to add another layer of insulation, in addition to the clear coat, to the metal layer 16. In FIG. 3D there is also shown a single hard coat layer 20a overlying the outer, external, surface of layer PL2a of the plastic assembly. The hard coat layers 20a, 20b provide wear and tear protection and reduce the scratching or marring of the underlying surfaces. In FIG. 3D, a contact chip 202, a signature panel 401 and a hologram 403 are shown attached and secured to the top of hard coat 20a.

FIG. 3E is similar to FIG. 3D except that, in this configuration, the clear coat layers and the top-coat layers are symmetrically applied to the top and bottom surfaces of the card assembly. Thus, a clear coat layer 18a overlies layer PL2a and a clear coat layer 18b overlies metal layer 16. The “hard” top-coat layer 20a overlies layer 18a and the “hard” top coat layer 20b overlies layer 18b.

The “hard” top coat layer (20a 20b) may be formed of electrically non-conductive nano-particles (e.g. silicon or ceramic particles or particles of any hard electrically non-conductive materials, also including polymeric (acrylic) carriers of nano-particles which may, but need not, be in a polymeric radiation cured vehicle. The hard top coat nano-particle layer may be applied (or formed) by atomizing, spraying, painting, roll coating, screen printing, thermal transfer or any like suitable method and processed by conventional automotive type spray guns, brushes, screen print equipment, roll lamination and any like suitable method.

By way of example, the thickness of each one of said top-coat layers (20a, 20b) is typically in the range of 1.5 to 15 microns.

Note that a signature panel 401, a hologram 403 and a contact chip 202 can be attached to the card assembly as shown in FIGS. 3D and 3E.

It has thus been shown that cards may be formed with just a clear coat (e.g., 18b) overlying the exposed surface of a metal layer or with just one “hard” top-coat layer (e.g., 20b) overlying the exposed metal layer. Alternatively, a hard coat layer may be applied so as to overlie a clear coat. In addition, it has been shown that a clear coat and/or a hard top-coat may be applied to the exposed surface of the plastic assembly. Protecting the major card surfaces of a card from wear and tear and abrasion is highly advantageous.

Hybrid cards bearing ESD protection, as described above, have a stable structure and the various layers do not delaminate. Cards may be manufactured by combining various subassemblies. The subassemblies can be formed so as to optimize their properties and characteristics as further discussed below.

Hybrid cards include a first plastic subassembly 12 attached to a metal layer subassembly 131 to which is then attached a clear coat to which is then attached a hard top-coat layer. Although this is advantageous, for purpose of economy hybrid cards can also be formed with only a clear coat or a top-coat attached to exposed surface of the metal layer.

Hybrid cards may be formed in a series of steps. The first step includes the lamination of two or more plastic layers and pre-shrinking these layers to form a first assembly 12. Typically, the magnetic stripe 123 is attached to the outer PVC layer, PL2a, prior to the first lamination. The second step includes: (a) the formation of a sub assembly 131 comprised of an adhesive layer 14 attached to a metal layer 16; and (b) the lamination of the first assembly 12 with subassembly 131 to form assembly 13. The third step includes the application of a clear coat layer 18 to the metal layer 16 or the application of a top-coat layer. If a clear coat is applied in the 3^{rd} step, then a fourth step may include the application of a hard top-coat layer 20b to the clear coat layer. A clear coat layer may be applied to a card assembly and cured as discussed above. Likewise, a hard top-coat layer may be applied to a card assembly and cured as discussed above.

A clear coat layer or a top-coat layer may be applied to an exposed metal surface. If a clear coat is applied first, a top-coat layer can then be applied to the clear coat layer. In a hybrid card, it is not necessary to have an ESD protective coating over the plastic assembly. However, if it is decided to do so, then a clear coat layer or a top-coat layer may be applied over the plastic assembly. As in the case of metal card, if a clear coat is applied first, a top-coat layer can then be applied to the clear coat layer.

Typically, a fifth step includes affixing a signature panel 401 above and on the outside of any protective coating because the signature panel needs to be on the outside. Generally, a hologram 403 may be affixed to the card at the same time as the signature panel. However, note that the hologram can be affixed before or after the application of a clear coat and/or a hard coat. Also, a contact chip 202 may need to be attached after the application of a top-coat to enable the chip to make physical contact with a POS device.

Some claims of U.S. Pat. No. 9,569,718:

1. A card comprising:
a layer of non-magnetic electrically conductive material having an inner surface and outer surface;
said inner and outer surfaces being generally planar and parallel to each other;
a first assembly of electrically non-conductive material attached to the inner surface of the layer of non-magnetic electrically conductive material; and
an electrically non-conducting protective coating overlying said outer surface for preventing said outer surface from making direct contact with any other surface; and
wherein said protective coating forms the outer layer of the card and includes the following:
(a) a clear coat layer of resin to provide electrical insulation to any surface it overlies; and
(b) a hard top-coat layer of electrically nonconductive nanoparticles in direct contact with and overlying the clear coat layer to provide both additional electrical insulation and protection against wear and tear and scratching to any surface it overlies; and
wherein said clear coat layer and said hard top-coat layer form the two outer layers of said card.

2. The card as claimed in claim 1 wherein the resin of the clear coat layer may be from any of the following an acrylic resin including, but not limited to, any of numerous thermoplastic or thermosetting polymers or copolymers of acrylic acid, methacrylic acid, esters of these acids, or acrylonitrile, an ultra violet (UV) curable resin blend including polyester, urethane, diol and carboxyl acrylates with ceramic particles, multifunctional acrylate, polymers or any like material; wherein the clear coat resin layer may be applied by spraying, screen printing, painting, powder coating; and wherein the clear coat layer may be processed by ultra violet (UV) curing, electron beam curing, oven heat, any suitable radiation curing method; wherein said layer of non-magnetic electrically conductive material is a metal layer; and wherein said card includes at least one of the following an RFID chip or a direct contact chip.

3. The card as claimed in claim 2 wherein the thickness of the clear coat layer may be in the range of 3 microns to 25 microns.

4. The card as claimed in claim 1, wherein the hard top coat layer of nano-particles includes a nano-particle layer formed from any of the following: silicon nano-particles, ceramics, any hard, electrically non-conductive, materials, or any hard particles; and wherein the top coat layer may be applied by atomizing, spraying, painting, roll coating, screen printing, or thermal transfer; and wherein the top coat layer may be processed by conventional automotive type spray guns, brushes, screen printing equipment, or roll lamination.

5. The card as claimed in claim 4 wherein the thickness of the hard top-coat nano-particle layer may be in the range of 1.5 to 15 microns.

6. The card as claimed in claim 1 wherein the hard top coat layer of nano-particles provides a protective coat which reduces wear and abrasion of the underlying clear coat and wherein the hard top coat layer also functions to add another layer of insulation to the electrically conductive material layer.

### Some Embodiments for Smartcards

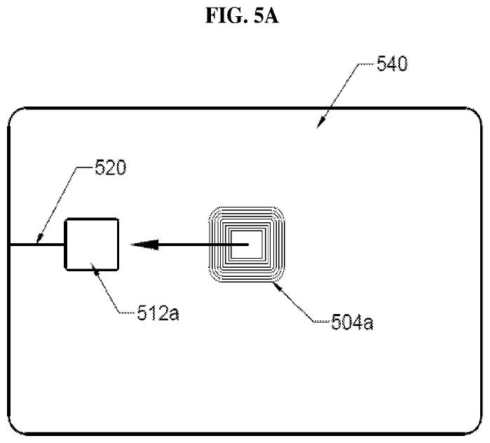

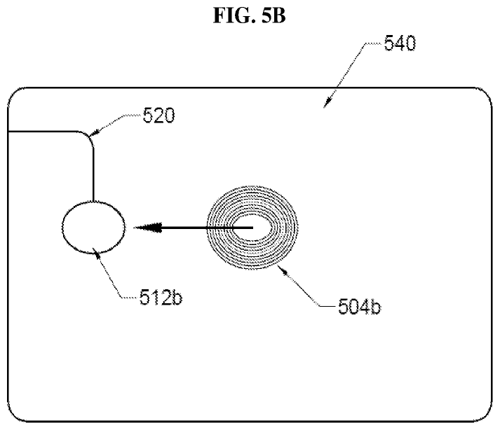

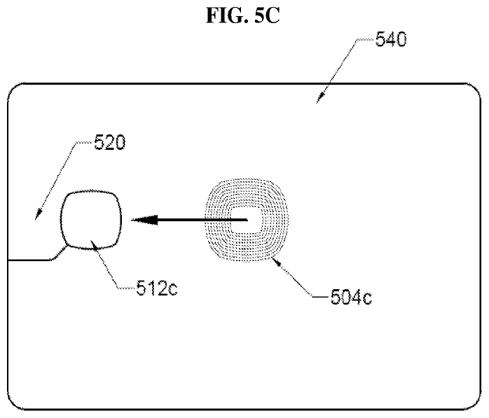

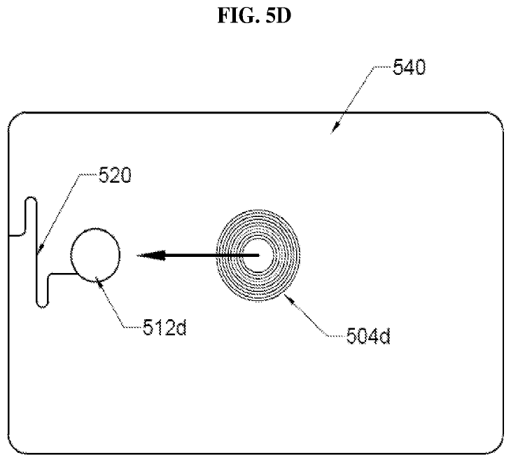

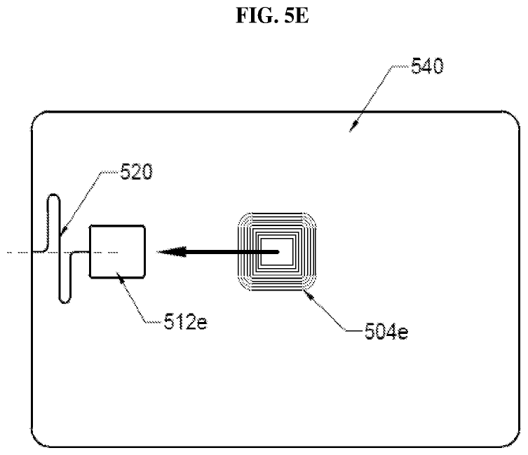

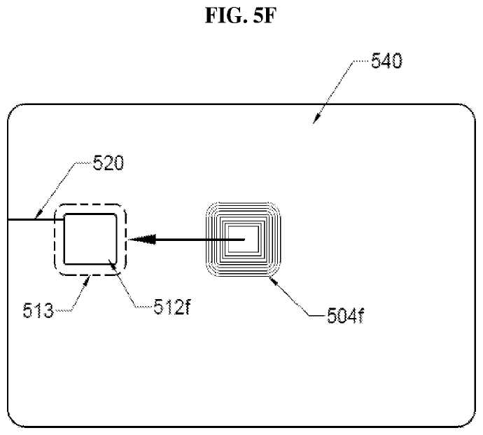

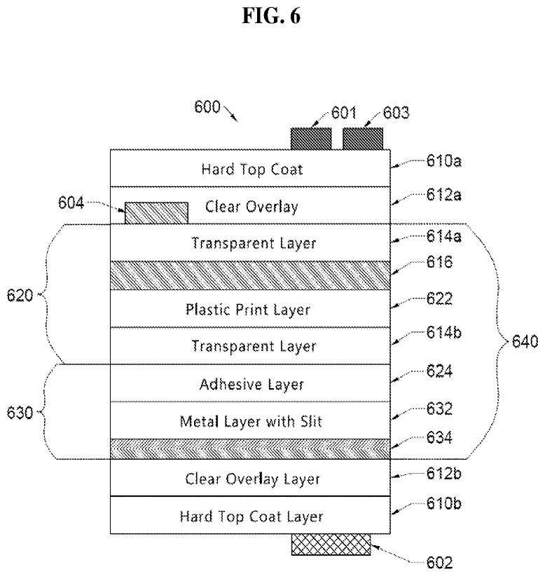

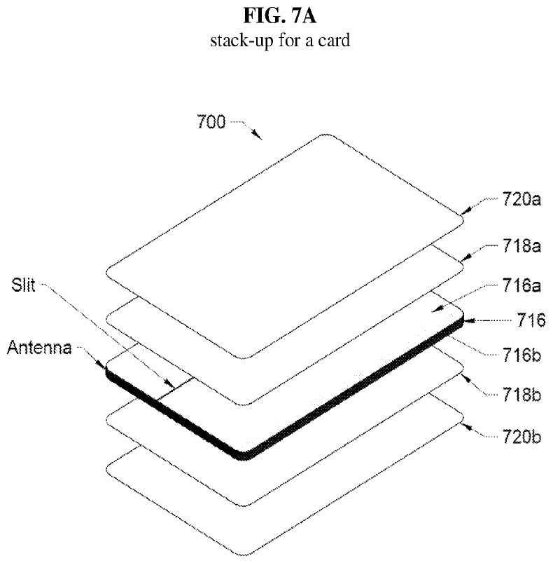

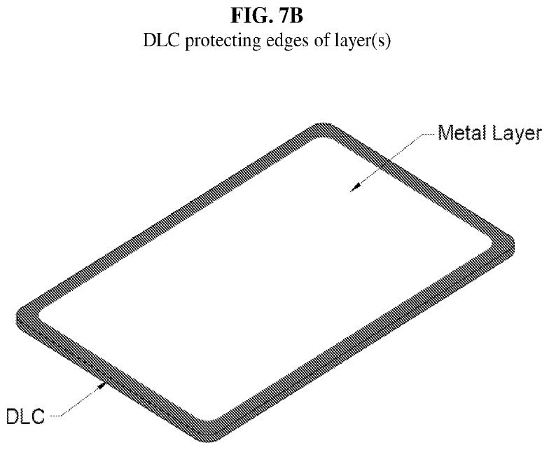

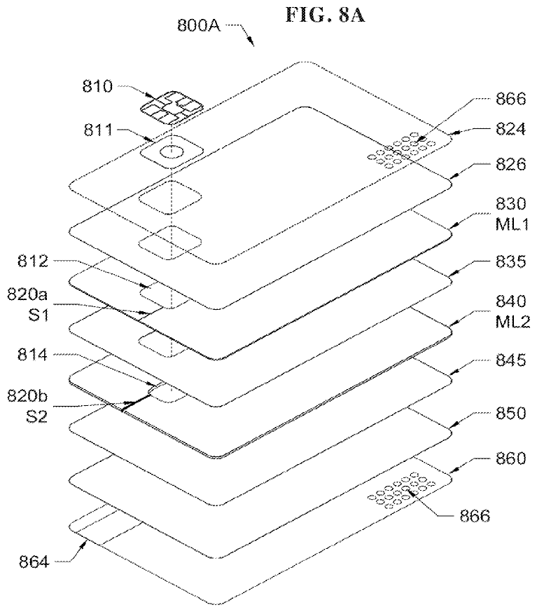

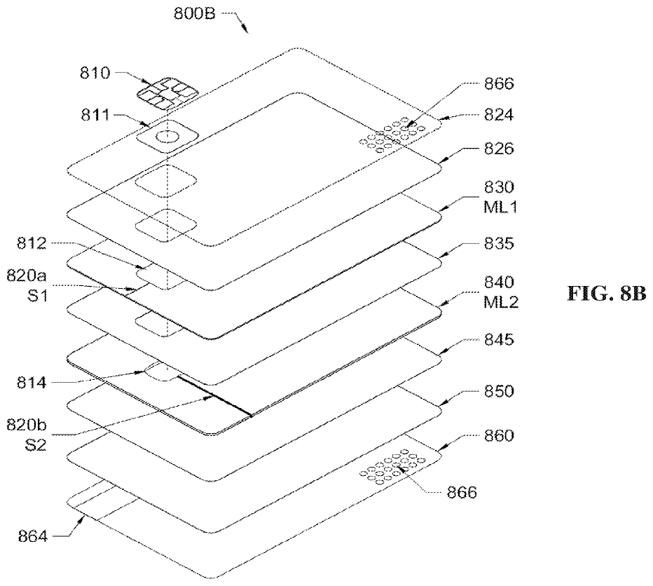

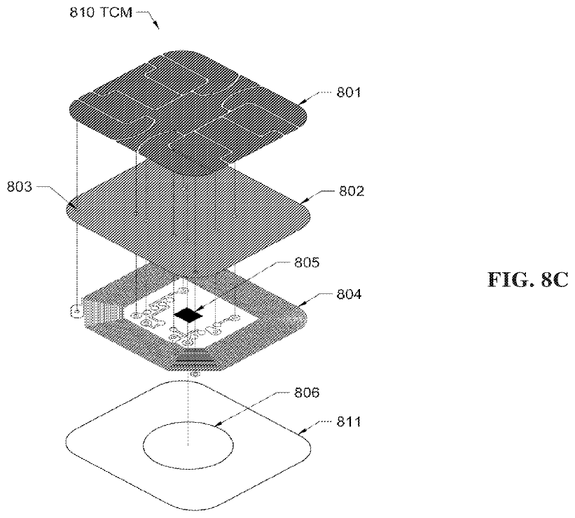

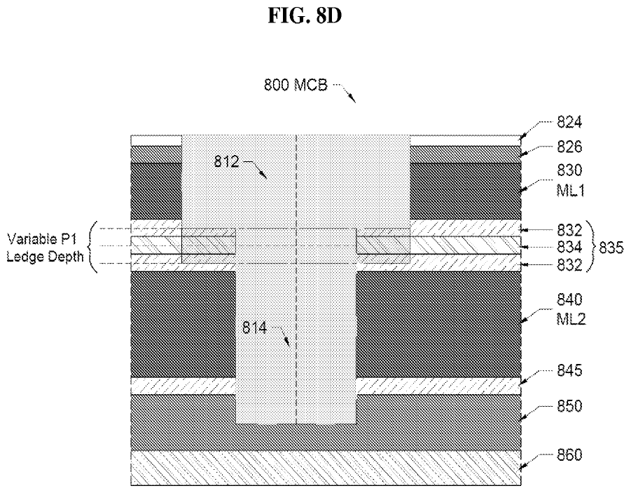

Some embodiments for smartcards will now be discussed, as follows:
module openings for smartcards, FIGS. 5A-5D
For optimum RF performance of a dual interface metal card with slit technology, the module opening to where the slit terminates allows surface currents to flow from the perimeter edges of the metal card body via the slit to the module opening, concentrating the current density around the metal edges of the module opening, and therefore its shape, geometry and overlap with the module antenna of the transponder chip module influence the system frequency, resonance curve, Q-factor and EMV performance. To minimize negative mutual inductance, it is imperative to match the shape of the module opening to the shape of the module antenna and to regulate the overlap to select the resonance frequency of the system.
some stackups for smartcards, FIGS. 6, 7A, 7B
To prevent an ESD event with a metal card, it is necessary to coat the metal with an insulating medium. A diamond-like-carbon coating which is non-conductive can be apply to the edges of the card body. The front and rear face of a metal card body can be insulated by using a hard coat lamination film in combination with an overlay layer. Alternatively, the exposed metal can be coated with several layers of ink, varnish or a polymer coating.
slit widths, etc. for coupling frames of smartcards, FIGS. 8A-8D
In a hybrid metal face transaction card having two metal layers and conforming to ISO thickness, the thickness of the front face metal layer (thin) with slit and the supporting metal layer (thick) with slit primarily determine the weight of the card body. If the thickness of the front face metal layer is 6 mils and the supporting metal layer is 12 mils, the resulting weight including the synthetic layers is 18 grams. By adjusting the thickness of each layer, the weight can be regulated. The slit in the front face metal layer should not be visible as it is not a desirable feature, and its presence needs to be disguised. A micro-slit of 50 μm can be camouflaged with ink, varnish or a polymer coating and can be filled with a resin or an epoxy prior to coating. The slit in the supporting metal layer (thick) should be narrow with a minimum width of 100 μm to avoid electrical shorting within the slit. The separation distance of the micro and narrow slit should be as close as possible, in order to reduce the risk of electrical shorting.

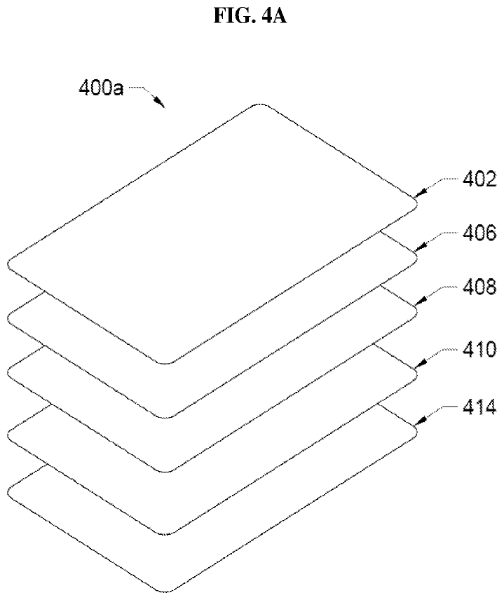

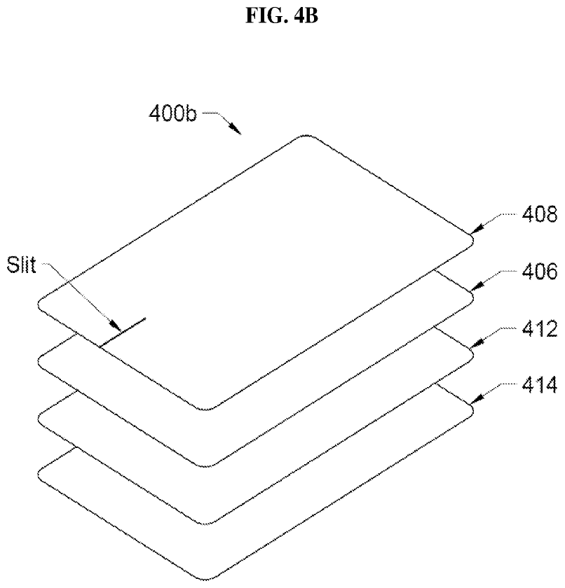

FIG. 4A illustrates a method for producing a plurality of RFID enabled metal core transaction cards (400a) with each transaction card respectively having a set of layers, wherein the set of layers includes an optional scratch resistant laser-reactive diamond coat (protective coating (ink, varnish or a polymer coating) or hard top-coat lamination film), a first laser engravable overlay (402) with digital reverse print, a first bonding layer (406), a metal layer (408) with slit or reinforced slit to act as a coupling frame, a second bonding layer (410), and a second overlay (414) with magnetic stripe, the method may comprise:
collating the set of layers (a diamond coat, a first overlay layer and a first bonding layer and separately, a second overlay layer with magnetic stripe and a second bonding layer) to produce loose material sheets, wherein the set of layers are tacked together;
laminating the loose material sheets to each side of the metal layer with slit to produce a finished material sheet (an array of card sites), wherein the finished material sheet is rigid and unified;
registering the post-laminated finished material sheet to add a set of alignment holes;
placing the finished material sheet on a vacuum table (chuck) via the set of alignment holes; and
singulating the finished material sheet to produce a set of metal transaction card bodies respectively for the plurality of transaction cards (400a).

Wherein collating the set of layers may further comprise:
capturing a set of position data for each of the set of layers using a visual monitor;
positioning each of the set of layers based upon the set of position data; and
tacking each layer of the set of layers to an adjacent layer using a spot-welding head.

Wherein laminating the loose materials sheet may further comprise:
performing a heating cycle on the loose material sheets to cause each of the layers to heat and partially bind to an adjacent layer and the metal layer with slit across the lateral entirety of the layers; and
performing a cooling cycle on the loose material sheets to cause each of the layers to cool and fully bind to the adjacent layer and the metal layer with slit across the lateral entirety of the layers.

Regarding the laminating step, the subassemblies and metal layer may be processed “in one go” under selected pressure and temperature conditions (adjusting the pressure and temperature (heating and cooling) over the lamination cycle time) to optimize the adhesion and dimensional changes of the materials (shrinkage) forming the card construction.

The resulting card (assembly, construction) may comprise:
the first “plastic” subassembly disposed on one side (front) of the card (front);
the metal layer, which functions as the core; and
the second “plastic” assembly disposed on the other (rear/back) side of the card.

FIG. 4A shows the stack-up of a card body 400a with a plurality of layers (402, 406, 408, 410, 414) that are combined (laminated together) to form an RFID enabled metal core transaction card 400a, which may also be referred to as a payment card. More particularly, the layers (402, 406, 408, 410, 414) forming the payment card 400a may include (from front-to-rear):
a front overlay 402 with digital reverse print which may be laser engravable
a front bonding layer 406
a metal layer 408 with a slit (not shown), functioning as a coupling frame
a rear bonding layer 410
a rear/back overlay 414 with digital reverse print which may be laser engravable

The resulting metal core transaction card (400a) is illustrated having five layers (402, 406, 408, 410, 414), which are laminated together. Fewer or more layers may be included in the stack-up. Optionally, a hard or diamond coat may be applied to the front surface.

The metal layer 408 with slit may have a thickness of 584 μm (23 mils). The slit may be reinforced to stabilize the mechanical stability of the resulting RFID enabled metal core transaction card. The resulting metal core transaction card may weigh 22 grams.

All dimensions set forth herein should be considered to be approximate, and illustrative.

More particularly, the construction of the metal core transaction card may comprise the following layers:

| | | |
|---|---|---|
| HARD or DIAMOND COAT (Optional) | | |
| On release carrier layer, deposited or coated | | |
| CLEAR PVC (402) | 50.8 | μm |
| Front overlay 50.8 μm (2.0 mils) | | |
| with digital reverse print | | |
| PRINTED INFO (PI) | ~13 | μm |
| Ink - UV Curable Flexible Ink (0.5 mils - 13 μm) | | |
| (Optionally, the clear PVC can be laser engraved) | | |
| BONDING ADHESIVE FILM (406) | 63.5 | μm |
| Double-sided Adhesive on PET Carrier | | |
| 63.5 μm (2.5 mils) | | |
| METAL LAYER (408) | 580 | μm |
| Single Metal Layer 23 mils | | |
| (Stainless Steel) with | | |
| Reinforced Slit (Metal Inlay) | | |
| BONDING ADHESIVE FILM (410) | 63.5 | μm |
| Double-sided Adhesive on PET or | | |
| PEN Carrier 63.5 μm (2.5 mils) | | |
| PRINTED INFO (PI) | ~13 | μm |
| Ink - UV Curable Flexible Ink (0.5 mils - 13 μm) | | |
| CLEAR PVC + MAGNETIC STRIPE (414) | 50.8 | μm |
| Rear overlay 50.8 μm (2.0 mils) with | | |
| digital reverse print | | |
| ELEMENTS (not shown) | | |
| Signature panel and hologram | | |

Total thickness pre-lamination: 834.6 μm (32.85 mils)
Total thickness, post-lamination: ~800 μm (31.50 mils)

In this, and some other embodiments disclosed herein, when the individual layers in card stack-up are laminated under pressure and temperature, the adhesive and synthetic layers shrink in thickness under the pressure of lamination press. The shrinkage may be about 25 μm, depending on the amount plastic to metal. The final ISO thickness should be approximately 760 μm (30 mils).

A method for producing a plurality of RFID enabled metal face transaction cards (400b) with each transaction card respectively having a set of layers, wherein the set of layers includes an optional scratch resistant laser-reactive diamond coat (protective coating (ink, varnish or a polymer coating) or hard top-coat lamination film), a metal layer (408) with slit or reinforced slit to act as a coupling frame and having an ink layer deposited on its front surface, a bonding layer (406), a print layer (412) and an overlay layer (414) with magnetic stripe, the method may comprise:
collating the set of layers (a diamond coat, a metal layer with slit, a bonding layer, a print layer and an overlay layer with magnetic stripe) to produce loose material sheets including the metal, wherein the set of layers are tacked together;
laminating the loose material sheets to the metal layer with slit to produce a finished material sheet (an array of card sites), wherein the finished material sheet is rigid and unified;
registering the post-laminated finished material sheet to add a set of alignment holes;
placing the finished material sheet on a vacuum table (chuck) via the set of alignment holes; and
singulating the finished material sheet to produce a set of metal transaction card bodies respectively for the plurality of transaction cards.

The layers of plastic material may include different plastic materials; and the plastic layers may be selected from the group consisting of a polyvinyl chloride (PVC) material, a polyethylene terephthalate (PETG) material, a poly carbonate (PC) material or any like plastic material.

The metal layer may be formed from one of stainless steel, titanium, brass, copper, aluminum, or any appropriate metal material or any clad metal layer.

The outer surface of the rear plastic layer may include at least one of a printed pattern, a magnetic stripe, a hologram and a signature panel.

The front surface of the metal layer may includes a pattern formed by at least one of etching, marking, engraving, lasing, embossing or coining the surface of the metal layer.

A Transponder Chip Module (TCM) may be placed in a recess in the card body to overlap the slit in the metal layer.

FIG. 4B shows the stack-up of a card body 400b with a plurality of layers (408, 406, 412, 414) that are combined (laminated together) to form an RFID enabled metal face transaction card 400b, which may also be referred to as a payment card. More particularly, the layers (408, 406, 412, 414) forming the payment card 400b may include (from front-to-rear):
a front metal layer 408 with a slit to function as a coupling frame having an ink layer
deposited on its front surface, the front metal layer may be laser marked, laser engraved
or mechanically engraved
a bonding layer 406,
a bottom print layer 412
a rear overlay with magnetic stripe 414.

The resulting metal face transaction card (400b) is illustrated having four layers (408, 406, 412, 414), which are laminated together. Fewer or more layers may be included in the stack-up.

The metal layer 408 with slit may have a thickness of 508 μm (20 mils). The slit may be reinforced to stabilize the mechanical stability of the resulting RFID enabled metal face transaction card. The resulting metal face transaction card may weigh 20 grams.

All dimensions set forth herein should be considered to be approximate, and illustrative.

More particularly, the construction of the metal face transaction card may comprise the following layers:

| | | |
|---|---|---|
| HARD or DIAMOND COAT (Optional) | 3 to 12 | μm |
| On release carrier layer, deposited or coated | | |
| ARTWORK | 25 | μm |
| Ink layer deposed on the metal layer 408 | | |
| Plain flood front | | |
| Ink: 0.5-0.6 mils, digitally printed flexible ink | | |
| Primer: 0.3-0.4 mils, digitally printed primer | | |
| METAL (408) | 508 | μm |
| Single metal inlay 20 mils with a reinforced | | |
| micro slit | | |
| ADHESIVE (406) | 64 | μm |
| PET with an adhesive layer on both sides | | |
| 2.5 mils | | |
| CLEAR PVC (412) | 125 | μm |
| Transparent PVC, digitally printed (5 mils) | | |
| PRINTED INFO | 25 | μm |
| Ink: 0.6 mils | | |
| Primer: 0.3-0.4 mils | | |
| CLEAR PVC + MAGNETIC STRIPE | 64 | μm |
| (DEFINE COLOR) (414) | | |
| Overlay with magnetic stripe 2.5 mils | | |

Total thickness pre-lamination: 823 μm (32.4 mils)
Total thickness, post-lamination: ~800 μm (31.50 mils)

In the above card constructions shown in FIGS. 4A, 4B, the bonding layers (406, 410, 406) may be replaced by a thin layer of adhesive (20 μm) on a high-density polyethylene (HDPE) liner. The PET adhesive layer can also be replaced by a layer of PVC with an adhesive backing (PVC WA).

In the construction of a metal face card (FIG. 4B) with the metal exposed (with the option of a hard or diamond coat), a logo may be mechanically engraved or the laser etched into its surface. To support the single metal layer with slit, the underlying layers may include a layer of fiberglass, carbon fiber or a rigid textile.

### Module Openings

US 2019/0236434 (2019 Aug. 1; Lowe; now U.S. Pat. No. 10,762,412), incorporated by reference herein, discloses DI CAPACITIVE EMBEDDED METAL CARD. A transaction card having a metal layer, an opening in the metal layer for a transponder chip, and at least one discontinuity extending from an origin on the card periphery to a terminus in the opening. The card has a greater flex resistance than a card having a comparative discontinuity with the terminus and the origin the same distance from a line defined by a first long side of the card periphery in an absence of one or more strengthening features. Strengthening features include a discontinuity wherein one of the terminus or the origin are located relatively closer to the first long side of the card periphery than the other, a plurality of discontinuities wherein fewer than all extend from the card periphery to the opening, a self-supporting, non-metal layer disposed on at least one surface of the card, or one or more ceramic reinforcing tabs surrounding the opening.

In the teachings of the '434 publication, there is no reference to the module antenna and obtaining optimum overlap with the P2 module in terms of EMV performance. '434 assumes that all module antennas in a transponder chip module are rectangular in shape which is incorrect. The module antenna has vertical interconnects which determines the shape of the antenna windings.

### Module Openings and Slit Designs for RFID Enabled Metal Transaction Cards

It is an object of the invention to improve the EMV performance of a metal transaction card by matching the shape of the module opening (MO) and its proportional size to the shape and geometry of the module antenna (MA) with the metal ledge surrounding the module opening (MO) overlapping the module antenna (MA). The proportional overlap (shape and dimensions) of the metal ledge relative to the module antenna (MA) determines the EMV performance in terms of activation distance, Q-factor and data transmission at minimum field strength, with increasing overlap uplifting the system frequency.

FIGS. 5A-5F are front elevation views of RFID enabled metal transaction cards, showing various module openings and slit designs (shapes or trajectories for the slit).

Reference is made to US 2019/0236434 (2019 Aug. 1; Lowe; CompoSecure), (now U.S. Pat. No. 10,762,412), incorporated by reference herein.

In performing x (horizontal) and y (vertical) torsion & bend tests on metal card bodies having a slit to enable contactless communication, the start point of the slit from the module pocket, its direction therefrom, the angle of emergence with reference to the perimeter edge, its length and its shape, all affect the EMV performance and the maximum force (Newton cm⁻¹) which can be applied to the card body before destruction. A straight slit offers the best performance in terms of EMV. A slit emanating from the module pocket at 45 degrees splits the horizontal and vertical forces. The feature or curved design of the slit is best implemented at a distance from the module pocket to prevent shorting. Therefore, the shape of the slit is a compromise between a straight line, one at an angle and one having an oscillation (sinusoidal) shape. Note the slit begins at the center of the module pocket and extends to the outer perimeter edge of the card body into the metal inlay. In the bottom recess area of the module pocket, the metal around the slit is removed during CNC milling of the pocket. Fake slits can be used for aesthetic purposes. The slit can be partially disguised behind the magnetic stripe or printed artwork. The slit can rise above or fall below the module pocket.

The slit may emerge from any of the four sides of the module pocket. The slit may overlap (underlay) the module antenna from the top, passing under the connecting bridge, passing under the center point or passing under any isolated metal on the contact side of the transponder chip module.

Embedded Metal Cards (aka Metal Core or Metal Veneer Cards) with Contactless Functionality have a single metal layer with a slit extending from a module opening to a perimeter edge of the card body.

This single metal layer with slit is sandwiched between layers of plastic, and can have a very stable card structure, if the metal layer has a thickness of 250 μm (˜10 mils) or 300 μm (˜12 mils). As soon as the metal thickness exceeds 380 μm (15 mils), the slit should be reinforced with a filler to prevent bending around the area of the slit and the module opening. In the case of the embedded metal card product, the slit does not need to be a micro-slit having a kerf of 50 μm, however as the width of the slit increases, ghosting of the slit on the front surface becomes evident.

In the case of the Metal Face Card (aka Metal Hybrid), the exposed front metal layer laminated to a rear plastic layer or layers requires a micro-slit to disguise the presence of the slit. A two-layer metal inlay construction (two metal layers of 152 μm (6 mils) and 305 μm (12 mils) separated by a dielectric (adhesive)) offers the best mechanical strength. A single metal layer requires that the micro-slit be filled for reinforcement.

The slit can be filled with a UV curing epoxy or a two-component adhesive, dispensed as a microfluidic droplet for in situ bonding of the slit under pressure and vacuum control.

Another important aspect in relation to EMV performance is the shape and geometry of the module opening, which should mirror the contour and geometry of the module antenna of the transponder chip module. The number of turns (windings) determines the resonance frequency of the module antenna and the dimensional foot print of the antenna while the shape and dimensional size of the module opening and its surrounding metal determines the overlap for inductive coupling with the module antenna which further influences the system frequency of the metal card. Therefore, a rectangular module opening in a metal card body with its surrounding metal (P2 metal ledge) overlapping a module antenna may not operate at optimum RF performance, if the shape and dimensional space is not aligned. Sharp straight corners of the antenna windings are not permissible in high frequency antenna design rules and hence a pure rectangular opening is not desirable for optimum performance.

ISO 7816 Minimum and Maximum Thickness Dimensions of a Card Body:
Min 0.68 mm (680 μm) to Max 0.84 mm (840 μm) or
Min 0.027 inch to Max 0.033 inch

FIG. 5A shows a metal layer or metal card body (540) with a straight slit (520) having a P2 rectangular module opening (512a) which matches the shape and a proportional dimensional size of the module antenna (504a). The shape of the module antenna is almost rectangular with curved corners having a radius which is required for optimum current flows.

FIG. 5B shows a metal layer or metal card body (540) with a curved slit (520) with straight sections having a P2 oval module opening (512b) which matches the oval shape and a proportional dimensional size of the module antenna (504b).

FIG. 5C shows a metal layer or metal card body (540) with an angled slit (520) having a P2 oblong/elliptical module opening (512c) which matches the oblong/elliptical shape and a proportional dimensional size of the module antenna (504c).

FIG. 5D shows a metal layer or metal card body (540) with a sinusoidal slit (520) having a P2 round module opening (512d) which matches the round shape and a proportional dimensional size of the module antenna (504d).

FIG. 5E shows a metal layer or metal card body (540) with a sinusoidal shaped slit (520) having a P2 rectangular module opening (512e) which matches the rectangular shape and a proportional dimensional size of the module antenna (504e).

FIG. 5F shows a metal layer or metal card body (540) with a straight slit (520) having a P1 rectangular module opening 513 which matches the shape and size of the front face module tape of the transponder chip module, and a P2 rectangular module opening (512f) which matches the rectangular shape and a proportional dimensional size of the module antenna (504f).

The proportional dimensional size is related to the percentage overlap of the metal ledge surrounding the module opening with the module antenna.

### Some Stackups/Constructions For Smartcards

FIG. 6 shows a transaction card 600 comprising: a layer or several layers of non-magnetic electrically conductive material (632) with a slit to function as a coupling frame, having an inner surface and outer surface; said inner and outer surfaces being generally planar and parallel to each other; an assembly of electrically non-conductive material attached to the inner surface of the layer or layers of non-magnetic electrically conductive material; and an electrically non-conducting protective layer overlying said outer surface for preventing said outer surface from making direct contact with any other surface; and wherein said protective layer forms the outer layer of the card and includes the following:
(a) a plastic overlay layer (612a and 612b) to provide electrical insulation to any surface it overlies; and
(b) a hard top-coat lamination film layer (610a and 610b) of electrically non-conductive material in direct contact with and overlying the plastic overlay layer to provide both additional electrical insulation and protection against wear and tear and scratching to any surface it overlies.

Note that the laser-reactive hard top-coat lamination film layer and the laser-reactive overlay layer may be replaced by a layer or several layers of protective coating (ink, varnish or a polymer) which can be laser marked, engraved or provided with thin film effects. The coating may be transparent, have a pigment, or have nanoparticles to promote the laser treatment process.

The transaction card 600, further comprising: (c) an insulating coating on the exposed edges of the non-magnetic electrically conductive layer or layers with slit; and wherein said plastic overlay layer and said hard top-coat film layer form the two outer protective layers of said transaction card. The transaction card 600, wherein: a thickness of the plastic overlay layer is in the range of 25 microns to 65 microns. The transaction card 600, wherein: the hard top coat lamination film layer comprises a protective film on a release carrier layer which is laminated to the underlying plastic overlay layer or directly to the non-magnetic electrically conductive material with a slit to function as a coupling frame, and whereby said release carrier layer is removed post lamination of the card body assembly. The transaction card 600, wherein: a thickness of the hard top-coat lamination film layer may be in the range of 10 to 15 microns. The transaction card 600, wherein: a thickness of the layer or several layers of non-magnetic electrically conductive material with a slit to function as a coupling frame may be in the range of 100 microns to 650 microns. The transaction card 600, wherein: the hard top coat lamination film layer provides a protective film which reduces wear and abrasion of the underlying plastic overlay layer and wherein the hard top coat lamination film layer also functions to add another layer of insulation to the electrically conductive material layer with a slit to function as a coupling frame.

The transaction card 600, wherein: said electrically non-conducting protective layer or layers overlying said outer surface is a first electrically non-conducting protective film; and wherein said first assembly of electrically non-conductive material includes a second electrically non-conducting protective overlay layer overlying said inner surface for preventing said inner surface from making direct contact with any other surface; and wherein said second protective layer includes at least one of the following:
(a) a second overlay layer; or
(b) a second hard top-coat lamination film layer.

FIG. 6 is a simplified cross-sectional diagram a card stack-up construction illustrating from the rear surface of the card body 600: an optional laser-reactive hard top coat lamination film layer 610a overlying a laser-reactive overlay layer 612a protecting a transparent layer 614a overlying a plastic print layer 622 having graphic artwork 616 which may further overly a transparent layer 614b; and from the front surface of the card body 600 illustrating: a laser-reactive hard top coat lamination film layer 610b overlying a laser-reactive overlay layer 612b protecting the exposed front surface of a metal layer 632 (with a slit to function as a coupling frame (not shown)) which has been laser etched or machined as an operation 634, with the back side of the metal layer 632 bonded to the plastic subassembly by an adhesive layer 624, in accordance with the invention.

FIG. 6 shows an embodiment of a stack-up for a card 600, comprising the following:
element 601: Signature panel
element 602: Transponder chip module or inductive coupling chip module
element 603: Hot stamped hologram
element 604: Magnetic stripe
element 640: Inlay assembly before application of protective layers

### Rear Side of Smartcard 600

element 610a: Optional laser-reactive hard top-coat lamination film layer
element 612a: Laser-reactive overlay layer with magnetic stripe

### Collated Plastic Layer Subassembly: 620

element 614a: Transparent plastic layer
element 616: Digital, screen or offset print layer
element 622: Plastic print layer
element 614b: Transparent plastic layer

### Metal Inlay Subassembly: 630

element 624: Adhesive layer of thermosetting epoxy
element 632: Metal layer with slit (not shown)
element 634: Operation of laser marking or engraving/Mechanical engraving
element 612a: Laser-reactive overlay layer
element 610b: Laser-reactive hard top-coat lamination film layer

### Front Side of Smartcard 600

Note that the laser-reactive hard top-coat lamination film layer and the laser-reactive overlay layer may be replaced by a layer or several layers of protective coating (ink, varnish or a polymer) which can be laser marked, engraved or provided with thin film effects. The coating may be transparent, have a pigment, or have nanoparticles to promote the laser treatment process.

FIG. 7A shows an embodiment of a stack-up for a card 700, comprising the following:
element 720a: Hard top-coat lamination film layer
element 718a: Protective layer—overlay layer
element 716a: Top surface
element 716: Metal core with slit to act as a coupling frame
element 716b: Bottom surface
element 718b: Protective layer—overlay layer
element 720b: Hard top-coat lamination film layer
   Compare FIGS. 6,6A of U.S. Pat. No. 9,569,718.

FIG. 7A is provided to illustrate that various layers can be stacked to form a metal core transaction card, with said metal core (with a single metal layer or multiple metal layers) having a slit to act as an antenna for contactless communication.

Protection against ESD discharged is provided for the planar surfaces (i.e., the top and bottom surfaces). In FIG. 7A, metal core 716 is shown with a top surface 16a and a bottom surface 16b, and with its perimeter edges coated with an oxide layer or a diamond-like-carbon coating. Protective layers 718a (plastic overlay layer) and 720a (hard top coat lamination film layer) are mounted above surface 716a, and protective layers 718b (plastic overlay layer) and 720b (hard top coat lamination film layer) are mounted below surface 716b.

The edges of the metal core 716 may be encapsulated by or coated with plastic or an insulating medium so that the edges are not exposed and thus would not come into electrical contact with any other surface.

Alternatively, the edges and the surrounding perimeter area of the metal core 716 can be coated with an insulating medium such as an oxide layer or a diamond-like-carbon coating. The teachings therein equally apply to a metal face transaction card.

An alternative approach to the abovementioned process is to use a single layer of metal (metal inlay with or without a micro slit), deposit ink and coat with lacquer, and followed by a heat cure process.

FIG. 7B is top view of a metal layer (without slit) in ID-1 format showing the non-conductive diamond-like-carbon coating around the perimeter edge of the card body. The thickness of the DLC coating is approximately 7-10 μm.

Process of Baking Ink onto a Metal Layer and Putting Down a Protective Coating

### Refer to FIG. 4B

In a first step, the metal 408 is cleaned in a chemical bath to remove oil and dirt, but also to roughen the surface for better adhesion of the ink.
In a second step, the metal inlay 408 is coated with a primer using a roller/curtain coater.
In a third step, the ink is applied using a screen-printing process. The ink is heat cured in an oven. In the last stage of the process, a clear coat or lacquer is applied and heat cured in an oven at an elevated temperature of 400° F.
In a fourth step, a hard top-coat film layer on a release carrier layer is applied for example using a lamination technique to the ink or paint baked metal layer, with the release carrier layer removed post lamination.

### Metal Sound, Shorting, Slit Width

Some objects of the inventions disclosed herein may be:
to safeguard (preserve) the metal sound of a metal face transaction card with several layers of plastic and adhesive which normally would dampen the drop acoustics of the metal card when tossed on a hard surface;
to allow the assembly of a component with an adhesive backing to be mounted on another adhesive surface without any degradation of the bond adhesion which would be achieved on another surface; to avoid electrical shorting of a slit in a metal layer by careful selection of the metal layer thickness relative to the slit width;
to mill a P1 opening in a metal layer or metal card body for implanting of a transponder chip module with the shape and geometry of the P1 opening reflecting the shape and geometry of the punched chip module with a contact pad arrangement on its face upside; and to mill a P2 opening in a metal layer or metal card body for implanting of a transponder chip module with the shape and geometry of the P2 opening for optimum RF performance reflecting the shape and geometry of the module antenna having windings which are not rectangular because of the obstacles of vertical interconnections forcing the corners to be angled or curved.

### Metal Sound Retention

To maintain the metal sound of a metal containing transaction card with two metal layers adhesively attached to each other, a PEN carrier may be used with a special adhesive system. For example, a medium may be constructed from 25 μm Polyethylene Naphthalate (PEN) film coated on both sides with a 25 μm coating of an epoxy based adhesive system which is thermosetting. The adhesive coating is flexible, non-tacky and of low friction.

When the double-sided adhesive on the PEN carrier is laminated with the metal layers in a lamination press with temperature and pressure applied over a certain cycle time, the thermosetting epoxy resin converts from a thermoplastic state (B-stage) to a crosslinked condition (C-stage) which is irreversible.

If temperature is later applied to the C-stage epoxy condition, it does not result in a reflow of the adhesive. This has a particular advantage, as it permits other components to be mounted with adhesive to the already cured epoxy on the PEN carrier. It has a further advantage that during machining (singulation) of the card bodies from an prelaminated inlay, the epoxy does not become tacky and destroy the milling tools.

### Avoiding Electrical Shorting Using Different Slit Widths

It is an object of the invention to have different slit designs enabling contactless communication in metal core or metal face transaction cards which combine EMV performance and mechanical stability of the card body. In the case of a metal face transaction card having a front face metal layer with a slit mechanically supported by an underlying metal layer with a slit, the shape and width of the slit on each metal layer may differ, with the front face metal layer having a micro slit (˜50 μm) and the supporting metal layer having a narrow slit (˜100 μm).

To avoid electrical shorts across a slit caused by particles and debris within and across the slit, it more advantageous to widen the slit for thicker metal layers, while reserving narrower slits for thinner metal layers.

FIG. 8A is a simplified cross-sectional diagram of a metal face card assembly for manufacturing a metal transaction card that can be personalized on the front and rear surfaces using a laser beam, and showing an arrangement where there are two metal layers, each having a slit of different width extending from an outer edge to an opening for a transponder chip module, and the slits are offset from one another. Reference may be made to U.S. Pat. No. 10,193,211 (FIG. 15B).

An exemplary stack-up of the card 800A is illustrated (from front-to-rear), comprising (all dimensions are exemplary, and approximate):
element 810:
   Transponder chip module (TCM) or inductive coupling chip module (ICM) with a thickness of ≤580 μm (“z”, or z-axis);
   The chip module has contact pads, and may be a dual-interface module.
element 811:
   Heat and pressure activated adhesive layer having a thickness of 60 μm;
   The layer 811 is the size of the module 810, and is on an underside of the module.
element 812:
   Module opening “P1” (MO) (e.g. 13.1 mm×11.9 mm) with a depth (z) of 250 μm having a shape and size to match the module tape (MT) with contact pads (CP) on its obverse (front) side and a module antenna (MA) with a number of windings or tracks on its reverse (rear) side, with the module tape (MT) having a thickness of 185 μm±20 μm;
element 814:
   Module opening “P2” (MO) (sized for example to 9.8 mm×8.8 mm for optimum overlap) with an additional depth (z) of 350 μm into the card body having a shape and geometry which follows the contour of the antenna tracks of the module antenna (MA) with a metal ledge surrounding the opening and the metal ledge overlapping the module antenna (MA) to obtain optimum inductive coupling;
element 820a:
   A micro-slit “S1” (50 μm) in the front face metal layer (830) extending from the perimeter edge to the P1 opening;
   The micro-slit may be color printed or color coated and its surface protected by a laser-reactive diamond coat. The laser-reactive diamond coat may be a protective coating having several layers of ink, varnish or a polymer coating, or a hard top-coat lamination film. The color and diamond coat may disguise or camouflage the presence of the micro-slit.
element 820b:
   A narrow slit “S2” (100 μm) in the supporting metal layer (840) extending from the perimeter edge to the P2 opening;
element 864:
   Magnetic stripe on a laser-reactive overlay layer (860);
element 866:
   Represents information inscribed by a laser into (engraved) or onto (marked) the laser-reactive overlay layer (860) or the protective coating layer (824);

Security elements: Hologram and signature panel not shown;

Post lamination varnish (PLV) on the front surface not shown;
element 824:
   Laser-reactive hard top-coat lamination film layer or a laser-reactive protective coating (ink, varnish or a polymer coating) which undergoes (may receive) laser treatment to personalize the card with a thickness of 10 μm to 25 μm;
element 826:
   Primer and ink layer (digitally, silk screen or offset lithographically printed layer) or a baked-on ink layer with a thickness of 10 m to 25 μm, alternatively a DLC, PVD or ceramic coating may be applied;
element 830:
   Thin front face metal layer (ML1), nominally of ID-1 size, and having a thickness for example of 152 μm (6 mils) having a micro-slit (820a) to function as a coupling frame;
element 835:
   Dielectric layer (or polymeric carrier layer) of PET or PEN with double sided adhesive (thermosetting epoxy) having a thickness of 75 μm (25 μm Adhesive, 25 μm Dielectric, 25 μm Adhesive);
element 840:
   Thick supporting metal layer (ML2), nominally of ID-1 size, and having a thickness for example of 305 μm (12 mils) having a narrow slit (820b) to function as a coupling frame;
element 845:
   Adhesive film layer of thermosetting epoxy having a thickness of 25 μm;
element 850:
   Transparent (translucent, white, or colored) print layer with a thickness of 152 μm (6 mils) with printed information (PI) comprising primer and ink applied thereto (digitally, silk screen or offset lithographically printed layer) with an additional thickness of 25 μm;
element 860:
   Laser-reactive overlay layer with a thickness of 64 μm (2.5 mils) to capture the magnetic stripe and security elements;

Total thickness of the card build (lay-up), pre-lamination: 848 μm (33.4 mils)
post lamination: approximately 760 μm (due to shrinkage)

Regarding the thickness of the front face (830) and supporting (840) metal layers, the thicknesses mentioned above can be changed to increase or decrease the weight of the card. Generally, the supporting metal layer (ML2) may be at least twice (2×) as thick as the face metal layer (ML1), including up to 3×, 4×, or 5. The supporting metal layer may be the layer that contributes most to the weight and feel of the card.

FIG. 8B is a diagrammatic view of a metal face laminated smartcard 800B, generally comprising (from top-to-bottom, as viewed): an 8 pin transponder chip module (TCM) or inductive coupling chip module (ICM) 810, a heat and pressure activated adhesive layer 811, a protective coating (ink, varnish or a polymer coating) or hard top-coat lamination film 824, a first, top (front face) metal layer (ML1) 830 which may have a thickness of approximately 152 μm. A micro-slit (S1) 820a is shown extending from the left edge of the card to an opening (MO) 812 for the transponder chip module (TCM). The front layer may comprise titanium, stainless steel, aluminum, copper, brass, tungsten, or any suitable metal or metal oxide layer. A dielectric layer with double sided adhesive 835 which may have a thickness of approximately 75 μm. A second, supporting metal layer (ML2) 840 which may have a thickness of approximately 305 μm. A narrow slit (S2) 820b is shown extending from the bottom edge of the card to an opening (MO) 814 for the transponder chip module (TCM). The supporting metal layer 840 may comprise of the same metal or a different metal as to metal used in the front face metal layer 830. A layer of non-conductive adhesive 845 which may have a thickness of approximately 25 μm.

The bottom plastic layer (transparent, translucent, or white) 850 may comprise of printed information (PI) and graphic artwork applied using conventional printing techniques, and its surface further protected by an overlay layer 860. The overlay layer 860 may have (have mounted thereon) a magnetic stripe 864 and may be laser marked with personalization data 866. The security elements (signature panel and hologram) may be hot stamped to the overlay layer (not shown).

An important aspect of this card construction is the use of a thin metal layer on the front face of the card body bonded to an underlying thicker metal layer for mechanical support, using a double-sided adhesive on a dielectric layer of PEN or PET, wherein the adhesive layer on each side of the dielectric after lamination is C-stage thermosetting epoxy cured to a crosslinked condition.

FIGS. 8A and 8B differ from one another primarily in slit orientations. In FIG. 8A, the slit S1 extends from the left side of the P1 module opening 812, towards the bottom of the module opening, and the slit S2 extends from the left side of the P2 module opening 814, towards the top of the module opening. In FIG. 8B, the slit S1 extends from the left side of the P1 module opening 812, from approximately the middle of the left side of the module opening, and the slit S2 extends from the bottom of the P2 module opening 814. The slits S1, S2 extend from the respective module opening 812, 814 to a corresponding (left or bottom) peripheral edge of the respective metal layer (ML1) 830 and (ML2) 840.

FIG. 8A has an interesting aspect with the front face metal layer having a straight slit (S1) at one side of the P1 module opening and a straight slit (S2) at same side of the P2 module opening in the supporting metal layer, and the two slits are offset slightly from one another, such as by a distance of less than 13 mm. As long as there is no short circuit in any of the slits or between the slits across the metal layers, the card will work fine, even if there is a short circuit between the metal layers (ML1, ML2) somewhere else. Generally, it may be preferable that the two slits (S1, S2) in the two metal layers (ML1, ML2) are offset from one another, yet located as close to one another as possible, without them overlapping (one being directly atop the other) so that the metal of one metal layer can support the slit of the other metal layer.

In some of the embodiments disclosed herein, a metallic holofoil which is electromagnetic transparent may be laminated to an underlying metal layer with slit, with the holofoil acting as a mechanical support for the metal layer with slit. The holofoil resembles a metal layer and can accept ink and primer to give color.

### Slits Front and Back

The slits on the front face metal layer and supporting (back) metal layer may have different widths. The slit on the front face may be a micro-slit S1 of approximately 50 μm or narrower. By defining a micro-slit, the slit may remain open (unfilled) and become discreet. The slit on the supporting metal layer may be a narrow slit S2 of approximately 100 μm or wider. Both slits may be slightly wider with a distinguishable shape where they commence (origin) at the perimeter edge of the card body and terminate (terminus) at the module opening. The upside of the front face metal layer incident to the laser beam will normally develop a wider slit relative the exit face (downside), therefore the slit may have a tapered cross-sectional profile. The micro-slit S1 and the narrow slit S2 both extend from the position of the module opening of the transponder chip module to the left edge of the card but are offset from one another.

### Preventing Shorting of the Slits

Use of extremely narrow slits (micro-slits) may present technical problems with electrical shorting of the slit by debris from the laser process and smearing of the slit during CNC milling; this may define a minimum width of slit for a given thickness of metal in a laminated metal face card—for example, a minimum slit width of 50 μm for a 100-160 μm (such as 152 μm) thick metal layer and 100 μm for a 300-350 μm (such as 305 μm) thick metal layer. An additional consideration is electrical shorting of the slit during use of the card.

In order to prevent shorting of the slit, the metal layer may be coated in a non-conductive material. This coating may also cover the exposed surfaces of the slit and thereby prevent electrical shorting by materials or particles that may ingress into the slit. For example, a diamond-like-carbon (DLC) coating that is electrically insulating may be applied to a thickness in the range 1-10 μm as a decorative surface finish. The applied coating may also be selected/designed to reduce the overall width of the slit. For example, a slit of 50 μm width with overall 4 μm DLC coating may be reduced in width to approximately 42 μm after coating.

Disguising the presence of the Micro-Slit

A holographic patch or a metallic foil which is electromagnetic transparent (aka a holofoil which is RFID friendly, https://www.cfcintl.com/home.asp, and U.S. Pat. No. 7,544,266) may be used to camouflage the presence of a micro-slit in a metal face transaction card. Coatings of ink, lacquer or varnish may also be applied to the area around the slit and or within the slit. The coating may have a moisture curing catalyst which provides adhesion and hardness. The metal layer may have a brush effect to further disguise the presence of the slit. Printing techniques to camouflage the slit with graphic elements is an alternative approach. The applied printing or coating may also result in a surface which is hydrophobic and or having an oleophobic pearl effect, which may further camouflage the presence of a slit. The slit may be filled with a resin, coating or an adhesive prior to applying the print elements and or top coat.

This disclosure also relates to metal face transaction cards having at least two layers of metal with a slit to act as a coupling frame (CF), having a first module opening P1 in the front face metal layer and having a second module opening P2 in the supporting metal layer, with the module openings machined to accept the insertion and shape of a transponder chip module (TCM) or an inductive coupling chip module (ICM) having an adhesive tape layer on its antenna side for attachment to the metal ledge which surrounds the P2 opening in the supporting metal layer, and with said antenna overlapping a portion of the metal ledge.

Further it is a requirement for security reasons that the transponder chip module when inserted and adhesively attached to a metal card body that the adhesion of the chip module is permanent and cannot be easily extracted, especially if backside spot pressure is applied to the reverse side of the chip module. The chip module should withstand a back pressure of 70 Newtons, but this depends on the adhesive and the surface to which the adhesive is applied. Reference is made to the CQM 2016 standard: TM-423.

FIG. 8C is a diagram (exploded perspective view) of a transponder chip module (810) showing the contact pads (801) on the face up side and the module antenna (804) with bonding pads on the face down side for connection to the chip (805), including the adhesive tape layer (811) for assembly of the chip module in a module pocket or cavity in a metal smartcard body.

An exemplary construction of a transponder chip module 810 TCM is illustrated (from front-to-rear), comprising:
element 801:
   8 contact pads on the obverse side of the dual interface (DI) chip module;
element 802:
   Glass epoxy tape with punch holes for wire bonding interconnections;
element 803:
   Plated through hole (PTH) for a vertical interconnect (VIA) from a connection bridge on the obverse side of the chip module to a connection pad or trace connected to the module antenna;
element 804:
   Module antenna with a certain number of turns (windings) with a specific shape and geometry;
element 805:
   RFID chip with bond pads for wire bond connection to the front face contacts and the antenna termination points Lₐ and L_{b};
element 811:
   Heat and pressure activated adhesive tape layer with an opening 806 to accept the mold mass (encapsulation) of the chip module;

In assembling a transponder chip module to a card body, a heat and pressure activated adhesive tape layer is first mounted and laminated to the 35 mm module tape with a row of modules across its width and many modules along its length. This is a prelamination stage (temperature of 120-140° C. at a pressure of 2-3 bar) before punching the individual chip modules out of the 35 mm module tape and embedding them under pressure and temperature into card bodies. The embedding process of permanently bonding a chip module in a module pocket or cavity requires a stamp tool temperature of 180-200° C. at a pressure of 65-75 N for a dwell time of 1.5 s. To reach maximum bonding strength, the surface should be clean and dry.

If the bond surface is an adhesive layer which re-melts during embedding when temperature is applied to the chip module under pressure, the resulting bond will be weak. To mitigate this problem of bonding to an adhesive layer, it is advantageous to use a thermosetting epoxy which has already been cured and has converted to the C-stage condition.

FIG. 8D is a cross-sectional diagram of the material layers in a metal face transaction card with a stepped module opening to accept the insertion of a transponder chip module. The milling depth of the first opening (P1) 812 is 250 μm±10 μm having lateral dimensions of 13.10 mm (width)×11.90 mm (height) with corner radii of 2.25 mm. The total milling depth of the second opening (P2) 814 is 600 μm±10 μm having for example lateral dimensions of 9.8 mm (width)×8.80 mm (height) with corner radii of 2.20 mm.

An exemplary stack-up of a metal card body (MCB) 800 with a chip pocket to accept a transponder chip module is illustrated (from front-to-rear), comprising:

### Chip Pocket

element 812:
   Module opening P1 (MO) (e.g. 13.1 mm×11.9 mm) with a depth (z) of 250 μm;
element 814:
   Module opening P2 (MO) (sized for example to 9.8 mm×8.8 mm for optimum overlap) with an additional depth (z) of 350 μm into the card body with a total depth of 600 μm;

### Material Layers

element 824:
   Laser-reactive hard top-coat lamination film layer or a laser-reactive protective coating (ink, varnish or a polymer coating) with a thickness of 10 μm to 25 μm;
element 826:
   Primer and ink layer (digitally, silk screen or offset lithographically printed layer) or a baked-on ink layer with a thickness of 10 μm to 25 μm;
element 830:
   Thin front face metal layer (ML1) having a thickness for example of 152 μm (6 mils) having a micro-slit to function as a coupling frame;
element 835:
   Dielectric layer 834 of PET or PEN with adhesive 832 (thermosetting epoxy) on both sides thereof, having a total thickness of 75 μm (832: 25 μm Adhesive, 834: 25 μm Dielectric and 832: 25 μm Adhesive);
element 840:
   Thick supporting metal layer (ML2) having a thickness for example of 305 μm (12 mils) having a narrow slit to function as a coupling frame;
element 845:
   Adhesive film layer of thermosetting epoxy having a thickness of 25 μm;
element 850:
   Transparent print layer with a thickness of 152 μm (6 mils) with printed information (PI) with an additional thickness of 25 μm;
element 860:
   Laser-reactive overlay layer with a thickness of 64 μm (2.5 mils);

Because of material and operational tolerances, the transponder chip module with an adhesive backing when implanted in the stepped module pocket may reside at variable depths on the P1 ledge. The adhesive backing (adhesive tape layer) may be bonded after milling to the PEN layer 834, the thermosetting epoxy layer 832 or the supporting metal layer 840. To ensure permanent adhesion, the adhesive system on the PEN carrier has to be fully cured (C-stage) and cannot remelt during the chip embedding process when temperature and pressure is applied.

Shape and Geometry of the P1 and P2 openings for Optimum Inductive Coupling

A transponder chip module (TCM) may comprise an upper portion comprising the module tape (MT) with contact pads on its front surface, and a lower portion comprising the RFID chip (IC) and mold mass. The upper portion may be larger than the lower portion, as follows.
the upper portion may measure 13.0 mm×11.8 mm, with a thickness of 185 μm (before the adhesive tape layer 60 μm is applied
the lower portion (mold mass) may measure 7.0 mm×7.0 mm, with a thickness of 350 μm

A recess or module opening (MO) in a card body for accommodating the transponder chip module may be stepped, having two portions, as follows.
an upper “P1” portion for accommodating the upper portion of the TCM
a lower “P2” portion for accommodating the lower portion of the TCM

The milling depth of the first opening (P1) 812 is 250 μm±10 μm having lateral dimensions of 13.10 mm (width)×11.90 mm (height) with corner radii of 2.25 mm. The total milling depth of the second opening (P2) 814 is 600 μm±10 μm having for example lateral dimensions of 9.8 mm (width)×8.80 mm (height) with corner radii of 2.20 mm.

The metal ledge which determines the proportional overlap with the module antenna has from the P1 edge rectangular dimensions of 3.3 mm (width)×3.1 mm (height) surrounding the P2 opening. This assumes the module opening with parallel sides is concentric with the module antenna, and equally the windings of the module antenna are routed symmetrical around the central bond area with wire bond connections to the chip.

The track (hence turns or windings) of the module antenna may measure approximately 100 μm in width. Spaces between adjacent turns of the spiral track may measure approximately 100 μm (chemical etching). For an antenna with 15 turns, the width of the antenna may be 2.90 mm measured from the outer winding to the inner winding. This means the width of the antenna within the dimensional space of the transponder chip module is 2.90 mm on the left and right side, as well as 2.90 mm on the top and bottom side. The inner horizontal width of the antenna is 6.8 mm and the inner vertical height is 5.8 mm, while the outer horizontal width of the antenna is 12.6 mm and the outer vertical height is 11.4 mm. The gap between the outer winding and the punched edge of the module tape in the horizontal plane is 0.20 mm and in the vertical plane is 0.20 mm. The module antenna would be rectangular in shape, if it were not for the vertical interconnect for the connection bridge, the vertical interconnect for the plating line, and the angled or rounded corner regions of the antenna to maneuver around said interconnections. Therefore, the module antenna is polygonal in shape and not rectangular. The chip module size before punching from a 35 mm reel of tape is 12.6 mm×11.4 mm (dimensional perimeter layout of the contact pads and module antenna), while the chip module size after punching from the reel of tape is 13.0 mm×11.8 mm. Therefore, the metal ledge from the perimeter edge of the implanted chip module dimensional overlaps the module antenna by 1.60 mm on the vertical sides and 1.50 mm on the horizontal sides, taking into account the gap between the outer winding and the edge of the punched module tape. But given that the module antenna has greater horizontal and vertical dimensions on its outer windings compare to its inner windings, optimum overlap can only be calculated with surface area (volume). Based on a P2 module opening of 9.8 mm (width)×8.80 mm (height), the aerial coverage of the metal ledge with the module antenna in percentage terms is 55% approx.

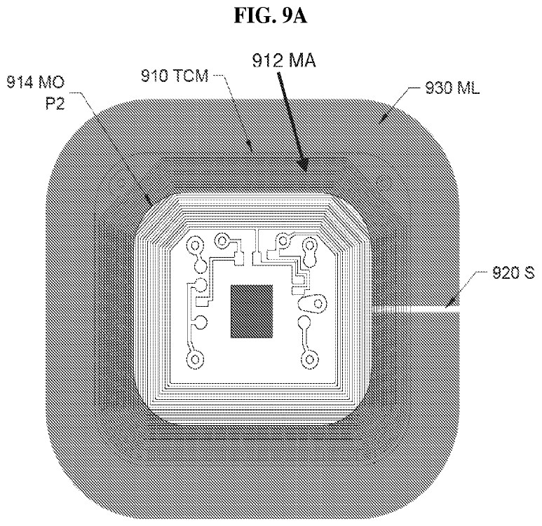

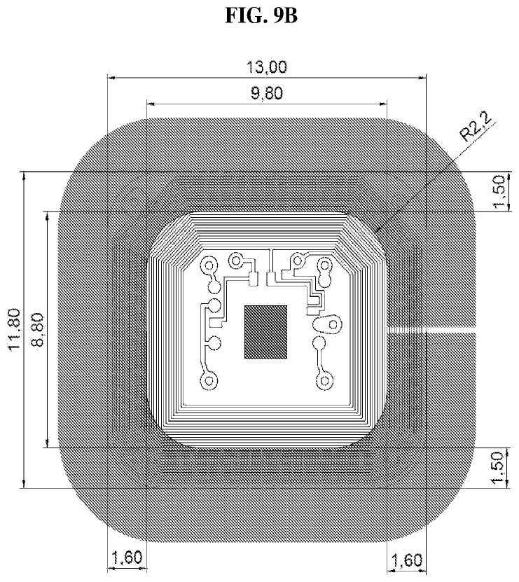

FIG. 9A is a diagram of a 15-turn module antenna (MA) 912 having a polygonal shape on the rear side of a transponder chip module (TCM) 910 showing a P2 module opening (MO) 914 in a metal layer (ML, or ML2) 930 having a slit (S, or S2) 920 to function as a coupling frame (CF).

FIG. 9B is a detailed modified diagram of FIG. 9A showing the 15-turn module antenna having a polygonal shape on the rear side of a transponder chip module and illustrating the layout and geometry of its windings with top angled corner regions (for vertical interconnections) and bottom curved corner regions. As discussed above, it highlights the punched module dimensions of 13.00 mm×11.80 mm; the P2 module opening having dimensions of 9.80 mm×8.80 mm; and the dimensional overlap (1.50 mm×1.60 mm) of the metal ledge with the module antenna. The resulting aerial coverage of the metal ledge with the module antenna in percentage terms is 55% approx.

Because the shape of the P2 module opening is rectangular and does not follow the contour of the module antenna which is polygonal in shape, it is not feasible to achieve an optimum RF performance of the inductive coupling system.

Generally, shape of the module opening (MO) should follow (mimic, “mirror”, match, be substantially the same as) the shape of the module antenna (MA) to have optimum performance. The module antenna (MA) is typically in the shape of a polygon having curved and angled corners. At least one of the first and second module openings may have a polygonal shape which matches the shape of the module antenna, with a size (somewhat smaller than the module antenna) that allows for the module antenna to at least partially overlap the metal layer outside of the module opening, in which case the slit (S) in the metal layer (extending to the module opening) will also overlap at least some of the windings (turns) of the module antenna.

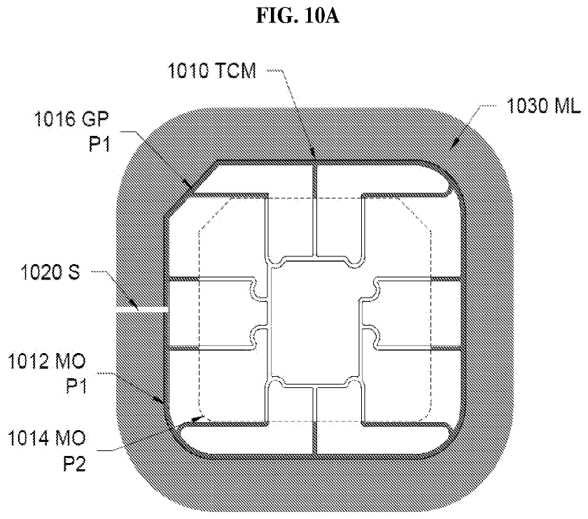

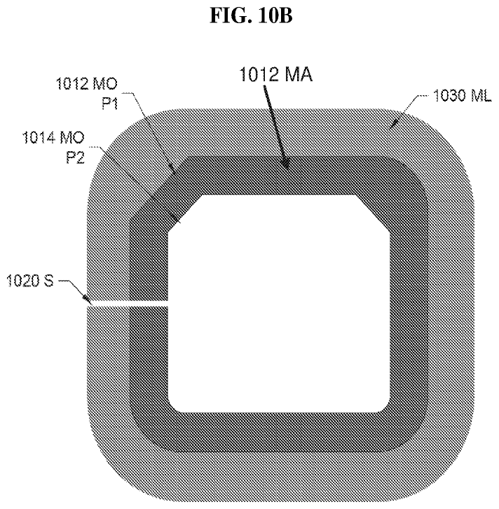

As shown FIG. 10A (below), it may be advantageous that the module opening (MO) has a corner with a distinctive alignment feature (1016, GP), and that the transponder chip module (TCM) has a corresponding feature at one of its corners, to ensure that the transponder chip module is inserted in a unique and proper orientation into the module opening.

FIG. 10A is a top view of a “P1” module opening (MO) 1012 in a front face metal layer (ML, or ML1) 1030 of a metal card body (MCB) having a slit (S, or S1) 1020, with an alignment feature (referred to as guiding or alignment post, GP) 1016 at the top left-hand corner and bottom curved corners to accept the insertion of a transponder chip module (TCM) 1010 having a matching shape and geometry as the P1 module opening, and to receive the transponder chip module 1010 in said opening (recess, cavity or pocket) in the correction orientation and to lock snugly in position to facilitate optimum coupling of the module antenna on the rear side of the transponder chip module (TCM) 1010 with an underlying metal layer or supporting metal layer having the P2 module opening (MO) outline 1014 behind the contact pads.

FIG. 10B is a top view of a P2 module opening (MO) 1014 in an underlying metal layer or supporting metal layer with slit (S) 1020 having a polygonal shape to match the shape of the module antenna (MA) 1012 with top angled corner regions and bottom curved corner regions.

The P2 module opening 1014 has a polygonal shape with bottom left and right curved corners and top left and right 450 angle corners which follows the contour of the module antenna, achieving optimum overlap with the module antenna of the transponder chip module.

While the invention(s) may have been described with respect to a limited number of embodiments, these should not be construed as limitations on the scope of the invention(s), but rather as examples of some of the embodiments of the invention(s). Those skilled in the art may envision other possible variations, modifications, and implementations that are also within the scope of the invention(s), and claims, based on the disclosure(s) set forth herein.

1. An RFID-enabled metal face transaction card comprising: a first metal layer (ML1; 1030) with a first module opening (PI); a second metal layer (ML2; 930) with a second module opening (P2; 914); wherein: the second module opening has a shape and geometry which matches the shape and geometry of a module antenna (MA; 912, 1012) of a transponder chip module (TCM; 910, 1010) which will be inserted into the card.

2. The card of claim 1, wherein: the first module opening has an alignment feature (GP; 1016) for ensuring correct alignment of a transponder chip module (TCM) inserted into the opening.

3. The card of claim 1, wherein: at least one of the first and second module openings has a polygonal shape which matches the shape of the module antenna, with a size that allows for the module antenna to at least partially overlap the metal layer outside of the module opening.

4. The card of claim 1, wherein: the second metal layer is at least approximately twice as thick as the first metal layer.

5. The card of claim 1, wherein: the first metal layer has a first slit (SI); and a second metal layer has a second slit (S2) which is wider than the first slit.

6. The card of claim 1, further comprising: a polymeric carrier layer which is a PET or PEN dielectric layer with thermosetting epoxy on both sides disposed between the first and second metal layers.

7. The card of claim 6, wherein the thermosetting epoxy is cured to an irreversible state (C-stage) when it is laminated with the first and second metal layers.

8. The card of claim 1, further comprising: a transparent, translucent, white, or colored print layer disposed behind the second metal layer; and a laser-reactive overlay layer disposed behind the transparent print layer.

9. The card of claim 1, further comprising: a transponder chip module (TCM) disposed in the first and second module openings.

10. The card of claim 9, wherein: the chip module has contact pads, and is a dual-interface module.

11. An RFID-enabled metal face transaction card comprising: a first metal layer (ML1, 830) having a first slit (SI, 820a); and a second metal layer (ML2, 840) having a second slit (S2, 820b); wherein: the first metal layer is thin, having a thickness of approximately 100-160 pm, and serves as a front face of the card; and the second metal layer is approximately twice as thick as the first metal layer, having a thickness of approximately 300-350 pm, and supports the first metal layer.

12. The card of claim 11, wherein: the first slit is a micro-slit having a width of approximately 50 pm; and the second slit is a narrow slit having a width of approximately 100 pm.

13. The card of claim 11, wherein: the first slit is offset from the second slit, yet the two slits are located as close to one another as possible, without overlapping.

14. The card of claim 11, further comprising: a color printing or coating (826) disposed over the first slit to disguise or camouflage the first slit.

15. The card of claim 11, further comprising: a laser-reactive diamond coat (824) disposed on a surface of the first metal layer; wherein the laser-reactive diamond coat comprises a protective coating having several layers of ink, varnish or a polymer coating, or a hard top-coat lamination film; and wherein the laser-reactive diamond coat protects the first metal layer and disguises or camouflages the first slit.

16. The card of claim 11, further comprising: a polymeric carrier layer which is a PET or PEN dielectric layer (835) with thermosetting epoxy on both sides disposed between the first and second metal layers; wherein the thermosetting epoxy is cured to an irreversible state (C-stage) when laminated with the first and second metal layers, a transparent, translucent, white, or colored print layer (850) with printed information (PI) comprising primer and ink disposed behind the second metal layer; and an adhesive layer (845) of thermosetting epoxy disposed between the second metal layer and the transparent print layer;
a laser-reactive overlay layer (860) disposed behind the transparent print layer;
wherein: the print layer has a thickness of approximately 152 pm; and the adhesive layer has a thickness of approximately 25 pm.

17.-19. (canceled)

20. The card of claim 19, further comprising: at least one of a magnetic stripe (864) and security elements disposed on the overlay layer; and
information (866) inscribed by a laser into or onto the laser-reactive overlay layer;
wherein: the laser-reactive overlay layer has a thickness of approximately 64 pm.

21.-22. (canceled)

23. The card of claim 1, further comprising: a first module opening (PI; 812) disposed in the first metal layer; a second module opening (P2; 814) disposed in the second metal layer; a transponder chip module (TCM; 810) disposed in the first and second module openings; and
a layer (811) of adhesive, the size of the transponder chip module, disposed on an underside of the chip module;
wherein the chip module has contact pads, and is a dual-interface module.

24.-25. (canceled)

26. A method of making an RFID-enabled metal face transaction card comprising: providing a first metal layer (ML1; 830) with a first slit (SI; 820a); providing a second metal layer (ML2; 840) with a second slit (S2; 820b); providing a dielectric layer (835) between the first and second metal layers; providing a transparent, translucent, white or colored print layer (850) below the second metal layer; providing an adhesive film layer (845) between the print layer and the second metal layer; and providing a laser-reactive diamond coat (824) on a surface of the first metal layer; wherein the laser-reactive diamond coat comprises a protective coating having several layers of ink, varnish or a polymer coating, or a hard top-coat lamination film; and wherein the laser-reactive diamond coat protects the first metal layer and disguises or camouflages the first slit.

27. The method of claim 26, further comprising: providing a laser-reactive overlay layer (860) below the print layer, a transponder chip module (TCM; 810) with a layer of adhesive (811), the size of the transponder chip module, disposed on an underside of the chip module;
prior to inserting the transponder chip module into the card, milling a first module opening (MO, PI) in the first metal layer, and milling a second module opening (MO, P2) in the second metal layer;
wherein the dielectric layer comprises: a layer (834) of PET or PEN with thermosetting epoxy adhesive (832) on both sides thereof.

28.-33. (canceled)
